(19) United States
(12) Patent Application Publication
(10) Pub. No.: US 2026/0349425 A1
(43) Pub. Date: Nov. 5, 2026

(54) ANTICIPATING THE CAUSE OF ABNORMAL OPERATION IN INDUSTRIAL MACHINES

(71) Applicant: PAUL WURTH S.A., Luxembourg (LU)

(72) Inventor: Cédric SCHOCKAERT, Wiltz (LU)

(21) Appl. No.: 19/117,549

(22) PCT Filed: Oct. 3, 2023
(86) PCT No.: PCT/EP2023/077364

§ 371 Date: Apr. 1, 2025

(30) Foreign Application Priority Data
Oct. 5, 2022 (LU) LU502876

(51) Int. Cl. G05B 23/02

(52) U.S. Cl. CPC G05B 23/0283

(57) ABSTRACT

A computer identifies a parameter state transition with a predicted occurrence in the future, wherein the parameter state transition is a critical transition due to a predicted increase in the likelihood that the operation mode of an industrial machine changes. The computer processes an operational multi-variate time-series by processing an operational multi-variate time-series that represents the machine operation during a particular operation time-interval that is ongoing at present. The computer provides a future multi-variate time-series that represents the predicted operation of the machine during a prediction time-interval that reaches into the future. The computer anticipates the parameter state transition if both of the following conditions are complied with (i) at least one particular parameter is predicted to have a value be different from a reference value in at least one deviating segment; (ii) the likelihood for the change in the operation mode of the machine is predicted to be increased.

### CROSS-REFERENCE TO RELATED APPLICATIONS

This application is a 35 U.S.C. § 371 National Stage patent application of PCT/EP2023/077364, filed on 3 Oct. 2023, which claims the benefit of Luxembourg patent application no. 502 876, filed 5 Oct. 2022, the disclosures of which are incorporated herein by reference in their entirety.

### TECHNICAL FIELD

In general, the disclosure relates to industrial machines, and more particularly, the disclosure relates to computer systems, methods, and computer-program products to identify parameters that—for a future time-interval—show deviations and become critical to the operation of the industrial machines.

### BACKGROUND

It is unavoidable—at least for the years to come-that individual humans eventually develop diseases. But humans seek to stay healthy as long as possible, and seek to avoid surprises that their health condition change or the like.

To meet these objectives, the understanding of disease causes (among them so-called “root causes”) is of paramount importance, and domain expertise in terms of biology, medicine, food science, etc. helps to define appropriate activities. Basically, activities can be differentiated between pro-active activities (the objective to remain healthy) and reactive activities (the objective to re-establish health if needed). In both cases, the activities involve monitoring conditions in general and monitoring them by small signs from the human body in particular. Reactive activities require monitoring with more professional expertise and more sophisticated diagnostics.

Much simplified, similar objectives apply to technical equipment, such as to industrial machines. Even terms such as “health” or “failure prevention” are used metaphorically. The machines should be operative within certain time-intervals (usually years or decades), and unavoidable interruptions should be predicted.

Experienced machine operators monitor their machines and know the interactions between machine components. In many situations, the operators know failure causes so that they can act accordingly. To give two examples, the machine operator will pro-actively keep the bearings of rotating parts under sufficient oil and will have some basic tools available for some basic repair.

However, together with increasing complexity of machinery, operator knowledge may not be available in all situations, for at least two reasons. First, the operator may not be able to monitor the machine completely. For example, bearings may be hidden: they may be difficult to access by the oil can, and the characteristic noise of a dry or broken bearing may be attenuated by the overall sound of the machine. Second, the operator may not be available at all, in scenarios that are contemplated in the context of an autonomous factory.

The complexity multiplies the lack of operator knowledge to an even worse scenario: a complex machine may fail completely if one of its components fails partly.

Maintenance (to prevent failures, or to repair in case of failures) belongs to the measures that let the machine stay healthy.

Hence, there is a trend for the machine operation (including maintenance planning) to be data-driven (in some sense corresponding to professional expertise and sophisticated diagnostics). Machine-related information may come from a variety of sources: from sensors that are associated with the machine, from shop floor systems, from devices that measure product properties or the like.

Computer-implemented tools may predict a time range in that a particular failure can be expected. Operators can take measures in advance to prevent failure (predictive maintenance).

Some of these tools provide prediction in a more sophisticated setting: For example, the prediction can be accompanied by Root Cause Analysis (RCA) that allows the operator better identify the measures, or can be accompanied by an estimation of the so-called Remaining Useful Life (RUL) of the machine if no maintenance would be performed.

Such tools may apply machine learning techniques, and the training of such tools requires the availability of so-called historical data and the identification of failures in that historical data (by expert annotations, or otherwise).

US 2019/0147300 A1 refers to a computer system that detects anomalies in multi-variate time-series. The computer receives the time-series from a monitored device, and the computers uses a pair of neural networks.

### SUMMARY

A computer performs a computer-implemented method for identifying a parameter state transition with a predicted occurrence in the future. The parameter state transition is a critical transition due to a predicted increase in the likelihood that the operation mode of an industrial machine changes in the future. The operation mode is a technical state of the machine. The computer processes multi-variate time-series, being pluralities of single-variate time-series. Each single-variate time-series represents a parameter of the industrial machine.

In a step anticipating the operation of the particular industrial machine, the computer processes an operational multi-variate time-series that represents the operation of the particular industrial machine during a particular operation time-interval that is ongoing at present. In that step, the computer provides a future multi-variate time-series that represents the predicted operation of the particular industrial machine during a particular prediction time-interval that reaches into the future.

In a step processing the future multi-variate time-series to anticipate the parameter state transition, the computer evaluates two and-related conditions (i.e., logical AND-conditions). The parameter state transition is anticipated if both of the following conditions are complied with:
(First condition) The computer processes parameters that are represented by single-variate time-series as part of the future multi-variate time-series. The first condition is met if the computer determines that at least one particular parameter is predicted to have a value that will be different from a reference value in at least one deviating segment.
(Second condition) The computer quantifies the deviation in that deviating segment for the at least one particular parameter. The computer thereby applies pre-defined rules. The second condition is met if the computer determines that the likelihood for the change in the operation mode of the industrial machine is predicted to be increased.

To anticipate the operation of the particular industrial machine, the computer can use an operation-anticipator module. The module can be implemented by a simulator, by a machine learning tool (that has been trained in advance with operational multi-variate time-series from past operations), or by a computer function (that applies mathematical relations and thereby processes data by formulas or look-up tables). Implementation approaches can be combined.

The computer can perform anticipating the parameter state transition by a criticality-anticipator module that is adapted to identify deviating segments in the single-variate time-series, by comparing the future multi-variate time-series with a reference multi-variate time-series, for each single-variate time-series separately. Deviating segments allow the computer to identify parameter deviations, to quantify deviation values, or to indicate variate specific errors that are predicted to occur during segment intervals in the future.

The computer can perform anticipating the parameter state transition by a criticality-anticipator module that is adapted to identify differences between numerical values that are obtained by pre-processing images or sound samples.

The computer can perform anticipating the parameter state transition by a criticality-anticipator module that has been trained in advance to determine the likelihood increase of the change of the operation mode of the industrial machine. The criticality-anticipator module can have been trained with historical data regarding the machine mode, wherein the machine mode has served as ground truth at the output, and data relating to parameters and quantified deviations has served as input data.

The computer can further perform a step simulating, by the following: The computer modifies the representation of the at least one particular parameter to obtain a set of parameter variations, wherein in the least one single-variate time-series that represents the at least one particular parameter, the computer replaces deviating segments by replacement segments obtained from a reference or generated with an auto-encoder. For each parameter variation separately, the computer anticipates the operation of the particular industrial machine, and evaluates if the at least one particular parameter would still have the value that would differ from the reference value and would still change the likelihood of the change in the operation mode of the industrial machine. The computer than selects the parameter variation with the least impact on the operation of the particular industrial machine.

The computer can execute the method as a method for identifying an action. Thereby the computer outputs the selected parameter variation as recommended action to an operator of the industrial machine.

The computer can limit the data processing during simulation to parameters that are actuator parameters.

The parameter state transition can indicate that the particular industrial machine turns to a particular operation mode that is abnormal machine operation.

Also, a computer program product that, when loaded into a memory of a computer system and executed by at least one processor of the computer system, causes the computer system to perform the steps of a computer-implemented method.

A computer system comprises a plurality of modules which, when executed by the computer system, perform the steps of the computer-implemented method.

In other words, using the computer system can differentiate parameters of a particular industrial machine to identify a subset of parameters that are critical parameters that cause abnormal operation of the industrial machine.

### BRIEF DESCRIPTION OF THE DRAWINGS

FIG. 1 illustrates a state-and-transition graph for a machine parameter, with nodes and edges;

FIG. 2 illustrates an industrial machine and a computer;

FIG. 3 illustrates illustrate a multi-variate time-series that represents pluralities of machine parameters;

FIG. 4 illustrates illustrate further multi-variate time-series that represent pluralities of machine parameters in different timing aspects;

FIG. 5 illustrates the multi-variate time-series of FIG. 3 in a differentiation into time-series available for a complete time-interval between start and end time-points, for a partial time-interval from the start time-point to an observation time-point applicable to a current operation of the industrial machine, and from a prediction time-point to the end time-point applicable for the future operation of the industrial machine;

FIG. 6 illustrates the multi-variate time-series with individual single-variate time-series in view of variate dependencies, wherein single-variate time-series are illustrated by cartesian coordinates;

FIG. 7 illustrates a time-diagram for steps which are performed by the computer modules operation-anticipator and criticality-anticipator, together with availability graphs for the multi-variate time-series in the different timing aspects;

FIG. 8 illustrates a continuation of the time-diagram for further steps which can be performed by a simulator module, together with further availability graphs;

FIG. 9 illustrates a symbolic illustration of a bearing;

FIG. 10 refers to the bearing of FIG. 9 and illustrates simulation of the temperature;

FIG. 11 repeats the illustration of the industrials machines and of the computer 200 of FIG. 2, but adds examples for the optional use of auto-encoders;

FIG. 12 illustrates optional variate pre-processing, by showing an adapter;

FIG. 13 illustrates optional variate pre-processing, by showing image data;

FIG. 14 illustrates optional variate pre-processing by data aggregation; and

FIG. 15 illustrates a generic computer.

### DETAILED DESCRIPTION OF THE DRAWINGS

### Parameter States

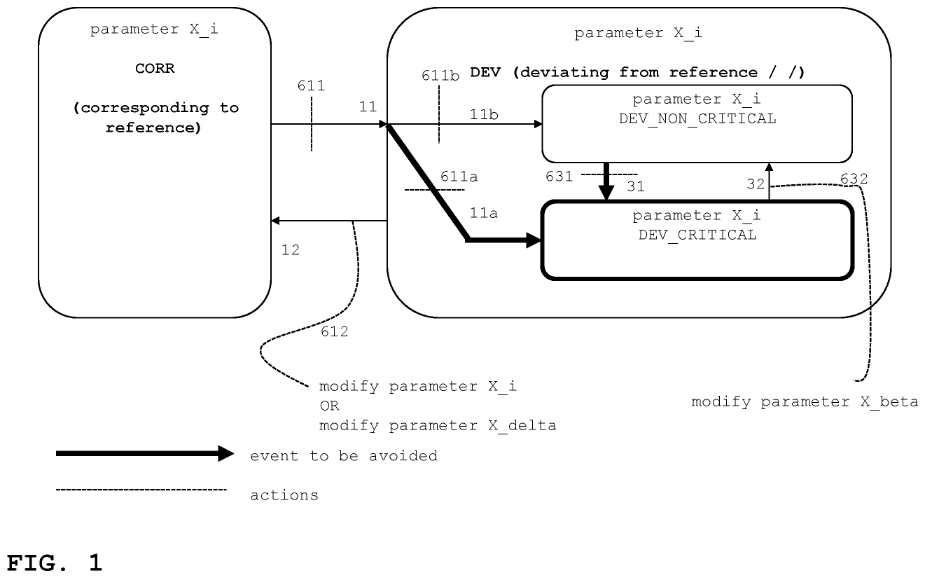

FIG. 1 illustrates a state-and-transition graph for parameter X_i of an industrial machine. For this overview, the particular semantic of parameter X_i (such as “temperature”, “vibration” or the like) does not matter, the machine parameter is therefore identified by the so-called variate index i. Nodes (shown by rectangles with round corners) stand for states, and directed edges (shown by arrows) stand for state transitions.

Parameters are associated with values. For simplicity, the description assumes that the values are numerical values. It is contemplated that values can be more complex data sets, such as images or sound samples and that such data sets are pre-processed to numerical values. Details are explained in the chapter “multi-modality and variate pre-processing” at the end of the description.

The description uses the term “deviation” for situations in that-during certain periods in the past, at present or in the future-the value of the parameter is different from a reference value. Terms and phrases such as “deviation”, “deviating”, “a parameter deviates” point to the state, not to the transition. In time-diagrams, deviations will also be represented by / / symbols.

A parameter (such as “X_i”) can change its state from “corresponding to reference” to “deviating from reference” (cf. arrow 11). For convenience, description and drawings refer to these two states by acronyms: CORR and DEV, respectively.

### Parameter State Transitions

State transitions can be defined for both directions, and as used herein:
the transition to the state DEV indicates that the state changes from CORR to DEV (arrow 11), and
the transition to the state CORR indicates that the state changes (back) from DEV to CORR (arrow 12).

State transitions can occur in the past, at present or in the future, and can be referred to as “past transitions”, “present transitions” and “future transitions”. For simplicity of explanation, the transitions should occur at time-points, so that the duration of a transition can be neglected here.

For example, a machine part may usually rotate with the parameter “rotation” in the value range between 1.000 and 2.000 rpm (state CORR). But when the machine part slows down to 800 rpm, the parameter “rotation” would see a transition to the state DEV (arrow 11, to DEV). The part may resume back to CORR, in the transition to CORR (arrow 12).

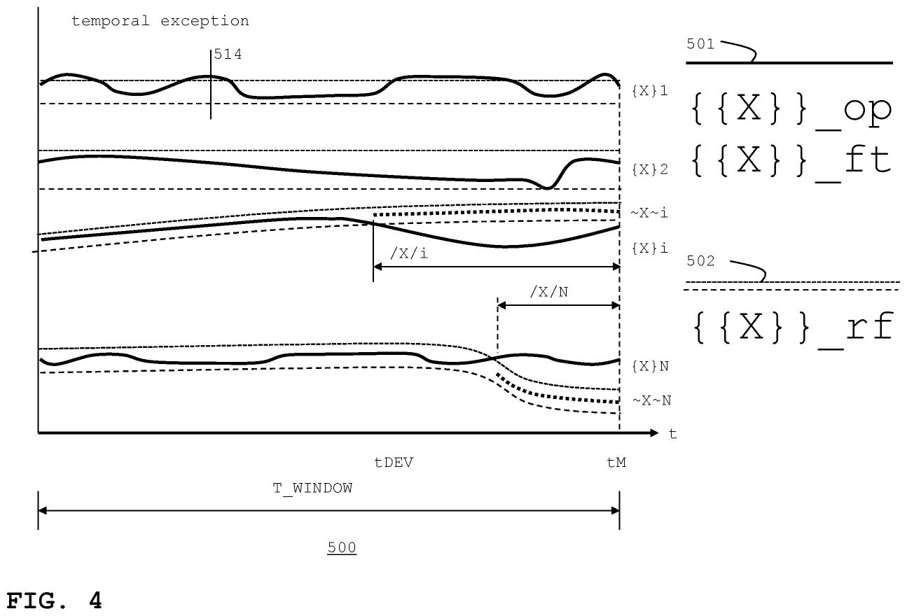

Usually, references have tolerances (or allowances) in their values in so-called tolerance bands. The bands can be given for values or for time-intervals. Exceptions can therefore be defined. For example, if the reference allows temporal value deviation, at least for some pre-defined interval (for example, for some minutes), the parameter would remain in the state CORR, it would not show a deviation (cf. an example in FIG. 4).

### Sub-States CRITICAL and NON_CRITICAL and Machine Mode

From a theoretical perspective, it appears impossible to operate an industrial machine in that all parameters remain constant over time. When a parameter changes, the industrial machines operates differently. However, not all parameter changes are relevant or decisive. Some parameter changes may even remain unnoticed.

It is well-known in the art to consider the operation of machines (and of other technical equipment) by so-called technical states. A machine state can be detected by a human observer and the human observer can attribute the state to the machine (e.g., by observing that the machine has stopped operating). To give a contrasting example, a change in the rotation speed of a machine component may be noticed, but the human observer may not attribute a particular state. It is also possible to assign states with the interaction with humans.

It is also well-known that certain changes in quantity lead to changes in quality. The quality of the machine operation may eventually change. The skilled person knows such changes as changes in the operation mode. As used herein, “influence the operation mode of the machine” is a convenient notation for an increase of the likelihood (or probability) that the operation mode changes (at present) or will change (in the future).

The operation mode of the machine can be considered as a machine state as well, but it can be assumed that parameter X_i in the state CORR does not influence the operation mode of the machine. But parameter X_i in the state DEV may or may not influence the operation mode of the of the industrial machine.

Simplified, the operation mode (of the machine) can be a further parameter X_mode for that states that are characterized, for example and simplified, by “normal behavior” or by “abnormal behavior”. Abnormal behavior can be defined (and detected according to pre-defined criteria), among them, and for example only, the following criteria:
The machine does not perform as expected, for example, because it delays the processing of physical materials, or because it emits substances to the environment and thereby exceeds thresholds (of allowable emissions).
The machine fails completely, it stops operating.
There is a danger or a security hazard to human operators.
There is a risk that some component of the machine can be destroyed.

The influence could be summarized, for example, as follows:
IF X_i=DEV_CRITICAL
THEN X_mode=abnormal
ELSE X_mode=normal.

The influence of the parameter can be related to other parameters, for example:
IF X_i=DEV_CRITICAL
AND
X_k=HIGH
THEN X_mode=abnormal
ELSE X_mode=normal.

The operation mode of the machine can be detected by humans when the machine operates (i.e., at present) or even by looking at data (i.e., the machine has operated in the past). The human detector is not necessarily the operator of the machine (cf. operator 190). For example, the mentioned processing delay may be detected in follow-up production stages, the emissions may be detected by regular inspections. A complete failure or step is likely to be detectable from any person nearby. Security hazards or the like can be revealed during regular inspections as well. The skilled person knows further occasions.

As the operation mode is easily detectable, data regarding the mode (as historical data) are available for training purposes as well.

In many situations, however, such simple cause-effect relations are not known. It can further be expected that the influence comes from multiple parameters (not only from X_i, but also von X_k and from other parameters). Nevertheless, for simplicity, the description continues to discuss states and transitions for parameter X_i.

FIG. 1 illustrates transitions within the sub-states by arrow 31 (to DEV_CRITICAL) and arrow 33 (to DEV_NON_CRITICAL). Transitions between the sub-states can also occur in the past, at present or in the future (i.e., also as past, present or future transitions). State transitions are concepts that are introduced here for simplicity of explanation. Two transitions can therefore occur at the same time.

Transitions (here in the example for parameter X_i) are therefore contemplated in the following:

### CORR to DEV_NON_CRITICAL (Arrow 11b)

At a particular time-point, parameter X_i can start deviating, but there would be no negative influence. Such a transition should be monitored because X_i could turn DEV_CRITICAL in some situations.

### DEV_CRITICAL to DEV_NON_CRITICAL (Arrow 32)

At a particular time-point, parameter X_i can be DEV_CRITICAL but due to changes in the machine (i.e., at that time-point, changes in other parameters), the deviation is tolerated. Negative influence to the operation mode of the machine would stop. Such a transition to DEV_NON_CRITICAL is desired, but in many situations not preferred because the state DEV would remain.

### DEV_CRITICAL to CORR, DEV_NON_CRITICAL to CORR (Arrow 12)

At a particular time-point, parameter X_i can return to a value that corresponds to the reference, and such a transition is highly desired.

### CORR to DEV_CRITICAL (Arrow 11a, Drawn Bold)

At a particular time-point, parameter X_i can start deviating such that the deviation negatively influences the operation mode (of the machine) from that time-point onwards.

### DEV_NON_CRITICAL to DEV_CRITICAL (Arrow 31, Drawn Bold)

At a particular time-point, parameter X_i can become critical but due to changes in the machine (i.e., changes in other parameters), the deviation is no longer tolerated. There would be negative influence to the operation mode.

The two transitions to DEV_CRITICAL (arrows 31 and 11a) are critical transitions due to the influence to the operation mode (X_mode).

The attribute “critical” here has a denotation as “decisive” or “relevant” (e.g., the operation mode changes), “important” (e.g., the machine operator may be alerted). Although in everyday use, the word “critical” has a negative connotation in the sense that something needs to be avoided, the influence to the operation mode can be negative or can be positive. Merely for convenience of explanation, the description prefers examples with negative influence over examples with positive influence.

The computer can determine influence to the operation mode (negative influence as described herein, but in theory also positive influence) by being trained.

### Events

The transitions to DEV_CRITICAL can be considered as events that should be (pro-actively) avoided. To highlight this aspect, the figure draws the arrows 11a and 31 by bold lines. If avoiding is not possible, such events should at least be predicted.

If such an event has occurred indeed, the transitions t to CORR (arrow 12) and to DEV_NON_CRITICAL (arrow 32) should be performed (away from DEV_CRITICAL).

### Actions to Enforce or to Prevent Parameter State Transitions

FIG. 1 also illustrates actions, by dashed lines near to the transition arrows. The actions can be differentiated according to transitions.
Action 611 prevents the transition of parameter X_i going from state CORR to state DEV.
Action 611a prevents the transition of parameter X_i going from state CORR to state DEV_CRITICAL.
Action 611b prevents the transition of parameter X_i going from CORR to DEV_NON_CRITICAL.
Action 631 prevents the transition of parameter X_i going to from DEV_NON_CRITICAL to DEV_CRITICAL.
Action 612 supports the transition of parameter X_i returning from DEV to CORR.
Action 632 supports the transition of parameter X_i becoming DEV_NON_CRITICAL.

Simplified, “state actions” prevent state transitions, and “transition actions” support transitions. From a slightly different perspective, the state actions are pro-active actions, and the transition actions are retro-active actions.

However, FIG. 1 shows the theory, and the actions would have to be implemented practically. In general, the actions can include maintenance (before failure, with or without stopping the machine), repair (usually with stopping, because failure has already occurred), calibration of sensors or actuators, replacing parts, filling in lubricants (such as oil), supplying energy (fuel, charge batteries etc.), changing parameters that are not X_i (such a taking an alternative path), and other measures.

The exact terminology does not matter, and it is not relevant if—for example—action 632 would be called “repair” or not.

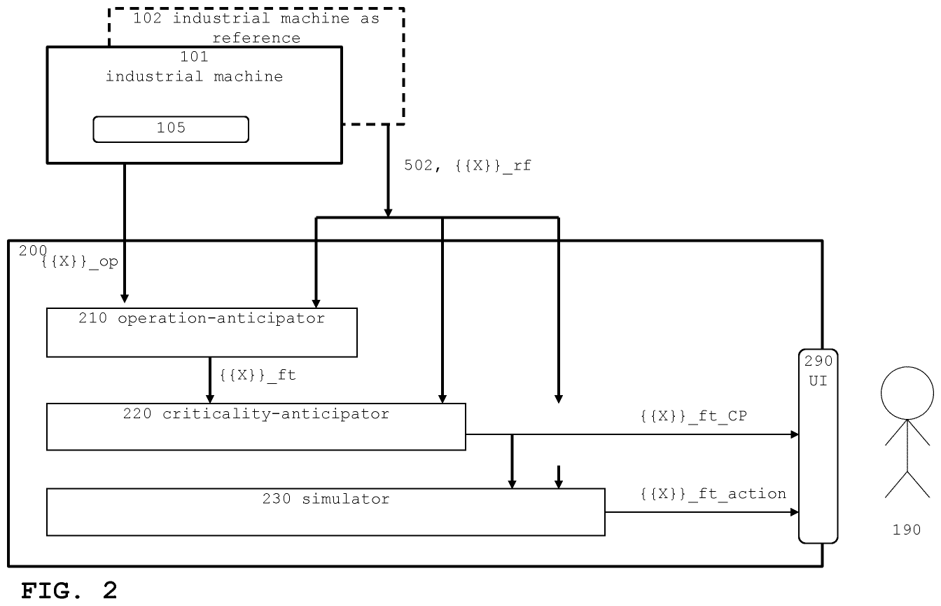

Industrial machine have actuators (such as, for example, equipment that replaces oil in bearings, applies cooling, limits the load that a robot or a vehicle has to carry, keeps the temperature of a component at a pre-defined value). The actuators are machine components that can be controlled by the machine operator, or by machine controllers (i.e., by computers that belong to the machine, cf. controller 105 in FIG. 2).

It is helpful to differentiate parameter X_i into an actuator parameter and a non-actuator parameter.
For X_i being an actuator parameter, the actuator can perform the action and can thereby trigger a transition (cf. arrows 12, 32).
For X_i being an actuator parameter, the actuator can perform the action and thereby avoid a transition (cf. action 611, 611a). For example, the actuator can be a heater that automatically keeps a temperature X_i within a pre-defined range.
For X_i being a non-actuator parameter, the actuator can act on a different parameter (that influences X_i). For example, X_i could be a parameter to describe quantity and quality of products that the machine produces, to represent substances that the machine emits to the environment, X_i could be measurement data for temperature, vibration etc.

The description will return to the actuator/non-actuator topic below because the differentiation can help to speed up computation (or at least to save computation resources).

The differentiation into (non-) actuator parameters is substantially independent from the above differentiation into state actions and transition actions. One and the same action can even be differentiated to be a state action or a transition action. The description therefore explains examples only:

An action 612 that supports the transition to CORR can be implemented (for parameter X_i) by (dashed lines)
modifying X_i (by an actuator that directly modifies X_i, the parameter would be an actuator parameter), or
modifying X_delta (by an actuator, wherein the modification parameter X_delta changes parameter X_i).

Action 632 that supports the transition from DEV_CRITICAL to DEV_NON_CRITICAL can be implemented by modifying other parameters (cf. the example with the logical AND).

Enforcing the transitions requires knowledge about parameter interdependencies. However, it is possible to learn such dependencies (by training a machine learning tool, for example). Modifying X_delta might have a different effect than modifying X_beta. Such effects can be quantified (e.g., in the time it takes to have X_i back to CORR). In that sense, FIG. 1 also illustrates the different potential contributors to state transitions. (Different contributors can be identified by simulation, as discussed at the end of the description under “casual relation”).

### Criticality

FIG. 1 illustrates that the state transition to DEV_CRITICAL of the single parameter X_i causes the machine to operate abnormally (X_mode=abnormal). It is however possible that two or more parameters that are in the states DEV at the same time cause this:
If X_i=Dev
   AND
   X_k=DEV
THEN X_mode=abnormal.

For simplicity of explanation, the description assumes that abnormal operation of the machine can be triggered by a single parameter going to state DEV.

A combination of multiple parameter in state DEV can also become the reason for the machine to operation abnormally.

A computer-implemented function to detect the transition of a single parameter to DEV_CRITICAL (alternatively to detect that one or more parameters in DEV cause X_mode to become abnormal) is the function of a criticality detector.

As the criteria for criticality are agnostic to the time-points, criticality can be detected for the past, for the present and for the future. Criticality detection comprises the logical step to detect the deviation (state DEV) and to evaluate if the deviation is critical (DEV_CRITICAL) or not (DEV_NON_CRITICAL).

As mentioned, historical data regarding the machine mode is available and it is possible to train a machine-learning tool to detect influence to the operation mode. The training set (with historical data) would comprise:
the machine mode as ground truth, and
data relating to parameters, quantified deviations (such as in deviating segments) for at least one particular parameter.

Using a machine-learning tool to detect influence is however not required.

### Other Perspective

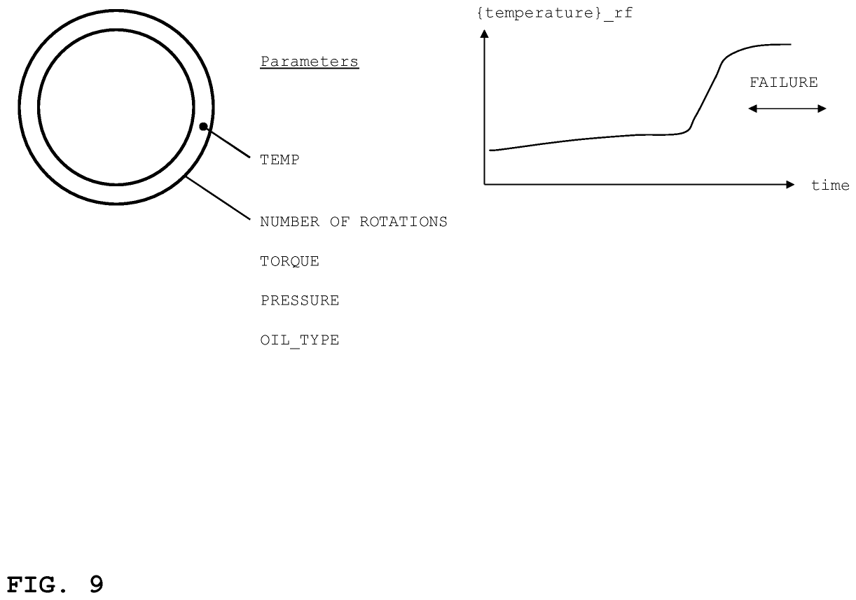

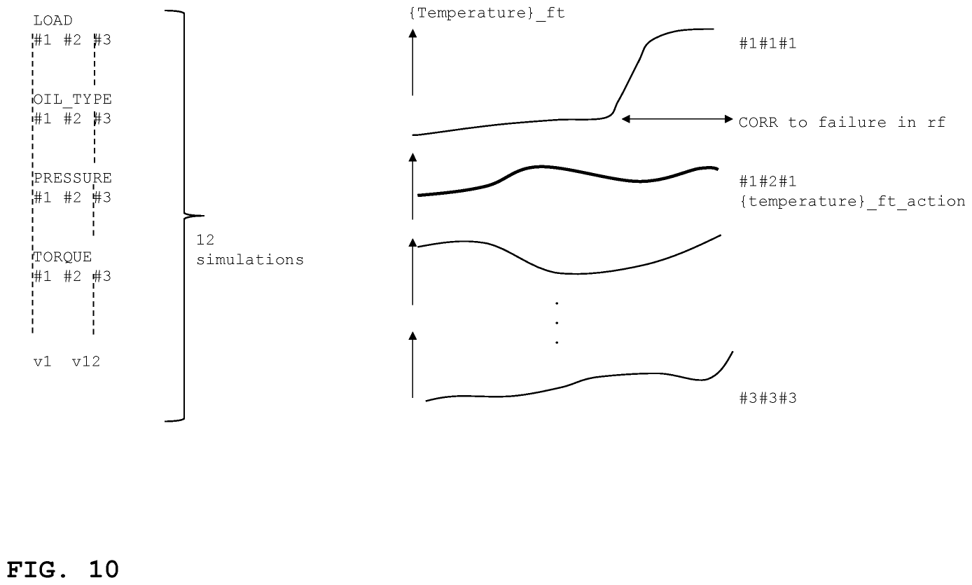

As a side-note, the principles of FIG. 1 would apply for beneficial deviations that would positively influence the operation mode, and states could be named BENEFICIAL instead of CRITICAL. As mentioned above, the term “critical” is used for influence in general (or increased likelyhood of mode change), no matter of negative or positive. Or, the state CORR does not have to be associated with normality, the state CORR can also be associated with failures (cf. FIGS. 9-10 for an example).

The simplified notation “critical parameter” or “CP” stands for a parameter in the state DEV_CRITICAL. The simplified notation “a parameter becomes a critical parameter” stands for the transition as illustrated by the two bold arrows 11a and 31 (unwanted event).

In view of the future, the phrase “a parameter will become critical” stands for the transitions (arrows 11a and 31) to occur in the future. More in detail:
At present, the state is CORR, and the transition CORR to DEV_CRITICAL (arrow 11a) will occur in the future.
At present, the state is DEV_NON_CRITICAL, and the transition to DEV_CRITICAL (arrow 31) will occur in the future.

Other actions can be described accordingly.

### Enhancements

The state-and-transition graph for parameter X_i of FIG. 1 could be enhanced by taking repetitions into account. Within predefined time-intervals, transitions can occur multiple times. The sequence of CORR to DEV, DEV to CORR, CORR to DEV and so on can serve as an example. If such a sequence is observed without certain intervals, the transition back to CORR can be ignored so that the parameter X_i would keep its state DEV (potentially then called “consistently deviating). To give an illustrative example, transitions may be accompanied with micro crack in some machines parts, and the accumulation over time of such micro cracks could lead to failure (X_mode =abnormal).

### State Changes in Past, Present and Future

The description describes the progress of time by consecutive absolute time-points “t_” as well as by the relative distinction into “past”, “present” and “future” time. At “present time”, the industrial machine is in operation, and at the “current time-point” t_current, data is available to a computer so that the computer can start executing steps of the computer-implemented method. The time it takes to communicate data from the machine to the computer can be neglected so that t_current marks the “present” and divides the time between “past” and “future”.

The description occasionally refers to the future by terms such as “anticipate” or “predict”, being synonyms.

As it will be explained with more detail below, the computer represents the machine parameters by time-series {{X}}. In such time-series, parameter X_i is one parameter among i=1 to N parameters (or “variates”).

When, for example at present, the machine slows down (starting to show abnormal behavior), an experienced operator may immediately see a broken bearing as the reason for such abnormality (CORR to DEV_CRITICAL, arrow 11a). However, modern industrial machines are complex and shows a relatively high inter-parameter dependency.

The complexity even raises further:
At present, to identify a parameter as being in the state DEV, the computer-in principle only needs to compare the parameter value to a reference value, wherein the parameter and its reference are usually corresponding in type (e.g., “rotation” values for both). The computer does not have to identify the time-point when the transition to DEV has occurred. (This is however suitable to identify tDEV, cf. FIG. 4.
At present, to identify the parameter as being in the state DEV_CRITICAL, the computer may need to consider co-parameters of the machine (X_k, etc.). It does not matter if the co-parameters deviate or not.
At present, to identify the reason (or “cause”) for a parameter to be DEV (or even DEV_CRITICAL) requires even more data processing.

These complexity topics are even more severe for predictions into the future, to identify a parameter that will be in the state DEV, to identify that the parameter also will be in the state DEV_CRITICAL, and to identify the reason that will develop in the future.

### Example

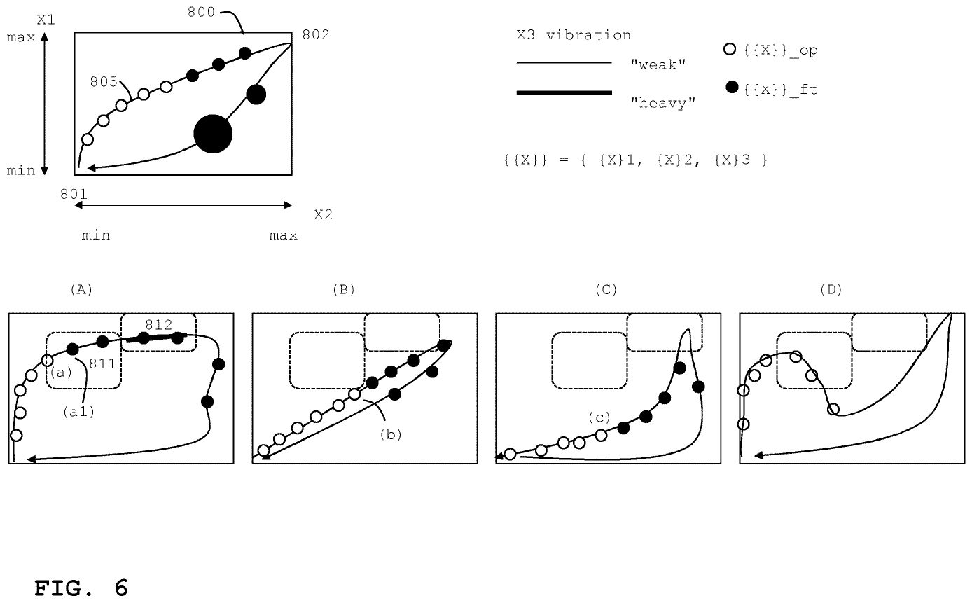

In an illustrative example for this complexity, the description promotes the rotating part (of the machine) to a vehicle and investigates the vehicle movement inside a factory (cf. FIG. 6). For a particular path (i.e., parameter “path”), the computer identifies “vibration” as a parameter to become DEV_CRITICAL if the vehicle would continue that path. In the example, heavy vibration would be critical because the vehicle carries a load.

The presence or absence of the load is a (binary) operation mode parameter. This parameter “load” is potentially influenced by heavy vibration. When the vehicle is loaded (i.e., carries the load), the influence may be negative. When the vehicle moves without load, the influence may be negligible.

In other words, the deviating parameter “vibration” has negative influence on other parameters, such as on the parameter “load”. The above-mentioned destruction risk applies here. In plain English, the load may simply fall off when the vehicle shakes too much. Operators usually try to avoid that.

Letting the vehicle go without load (“vibration” becoming NON_CRITICAL, arrow 32) would tolerate heavy vibration, because the vehicle can't lose its load. The parameter “load” does no longer contribute to criticality (cf. the statement with logical AND). However, such an approach may not be suitable for industrial settings, at least not always.

To avoid transitions to DEV in general (and to DEV_CRITICAL more in particular), the computer proposes a particular action: to take a different path (modify the parameter “path”, action 612). Or, performing the particular action would trigger a state transition to CORR, when the loaded vehicle has already experienced heavy vibration, action 612). Or, performing the particular action would keep the state CORR (if the vibrations are still weak, action 611).

The description then expands the example to the identification of the cause, and taking the parameter “surface” into account: the floor may be bumpy in certain areas, and an alternative action calls for repairing the floor.

But it is noted again that the computer is mostly agnostic to the semantics. For the computer it does not matter if the vehicle carries a load, if the vehicle shakes somewhere in the factory, or if the floor could be repaired. The computer processes data.

### Likelihoods

As explained, a parameter in in the state DEV_CRITICAL is related to abnormal machine operation, but the computer needs to distinguish this parameter from many other parameters. As used herein, an identification of a particular parameter as DEV_CRITICAL is rather the determination that this parameter has higher likelihood to be (or to become) DEV_CRITICAL than other parameters. In other words, the operation mode of the machine may change or may remain, but a critical transition (to DEV_CRITICAL) increases the likelihood (or statistical probability) that the operation mode changes.

The computer executes the method at relatively high speed to identify critical parameters and the like as early as possible. In other words, there is a compromise between
identifying a critical parameter as exact as possible at relatively high resource usage (computer operation, also the complexity of software), and
finding the critical parameter as fast as possible with an accuracy that allows the operator to modify the parameter (or to repair/replace the machine component).

Optionally, the computer identifies an action that-if actually taken-decreases the likelihood that a parameter deviation becomes critical in the future.

Taking likelihoods in account is even more important for anticipating (unwanted) events in the future (in difference to establishing that an event has already occurred in the past). For simplicity, the description assumes that predicted events would actually take place (of no actions are taken), and that—optionally—identified actions really fit to the problem.

### Overview to the Industrial Machine and to Parameters

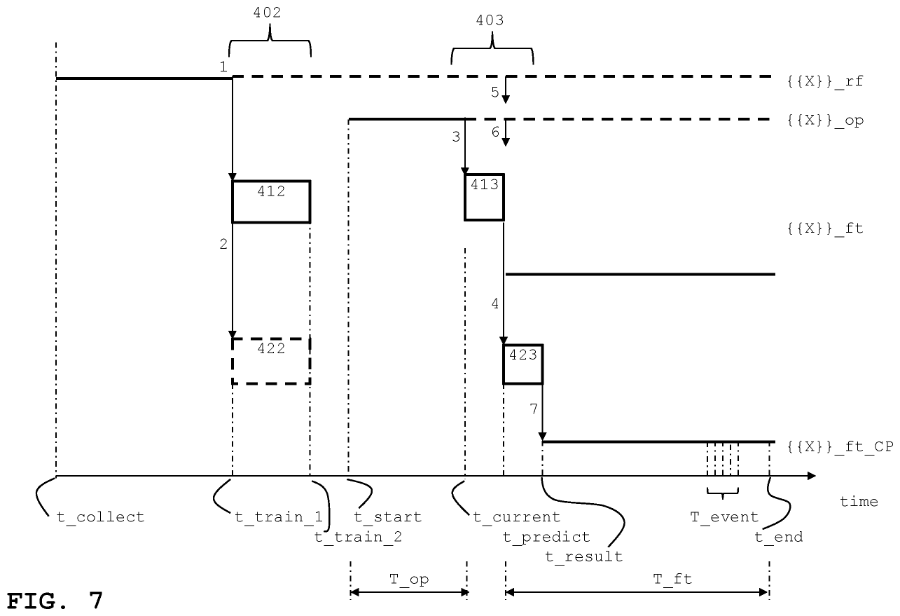

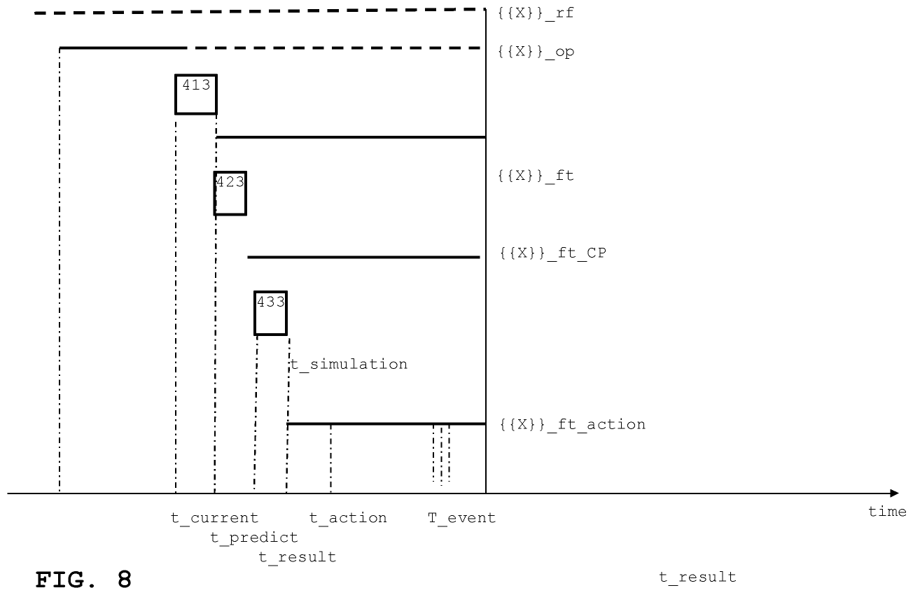

FIG. 2 illustrates industrials machines 101 and 102, and illustrate computer 200. Machine 101 (depending on implementations also machine 102) is controlled by machine controller 105. The figure shows computer 200 separately from controller 105. From a high-level perspective, both controller 105 and computer 200 are computers in the sense to have processors, memory, data storage etc. Computer 200 executes computer-implemented methods (such as method 403, the steps in FIGS. 7-8). In implementations, computer 200 could be implemented as part of controller 105.

Machine 101 is the industrial machine in operation, and machine 101 is also the machine under observation. Simplified, machine 101 may not operate as expected or may even fail, and the operator seeks measures to let machine 101 resume normal operation. Looking at the machine at present time, the following scenarios can be differentiated:
(Scenario PAST) In machine 101, a particular parameter may have turned to the state DEV_CRITICAL in the past. The state may remain DEV_CRITICAL at present. Computer 200 may assist operator 190 in identifying this particular parameter and in identifying the cause of being DEV_CRITICAL. Computer 200 may also identify a parameter to modify (cf. the above actuator, non-actuator difference). Such a scenario is related to descriptive and diagnostics analytics.
(Scenario FUTURE-EVENT) In machine 101, a particular parameter will turn to the state DEV_CRITICAL (within a predictable time-interval in the future), and computer 200 already (at present) assists operator 190 to identify this particular parameter. Optionally, the computer identifies the cause of being DEV_CRITICAL or at least the cause of being DEV. Computer 200 may also identify a parameter to modify (cf. the above actuator, non-actuator difference). Such a scenario is related to predictive analytics.
(Scenario FUTURE-ACTION) In machine 101, a particular parameter may turn to the state DEV_CRITICAL (within the predictable time-interval in the future), and computer 200 assists operator 190 to identify this particular parameter (at present), but the computer also identifies one or more actions that avoid that this particular parameter transitions to DEV_CRITICAL. Such a scenario is related to prescriptive analytics. In other words, the action is an event avoiding action.

Performing the action does not necessarily mean to stop the machine operating. The operator can schedule the action (before the event is expected to occur).

In the vehicle example, the computer predicts the parameter “vibration” to become DEV_CRITICAL and suggests actions: to take a different path, or to address the cause by repairing the floor. It is noted that the parameter “vibration” is a non-actuator parameter. But taking the different path acts on the actuator that steers the vehicle (the path here being an actuator parameter).

Experts in the machine maintenance community discuss analytics in a variety of papers, for example in
Sergei Nikolaev et al. “Hybrid Data-Driven and Physics-Based Modelling for Prescriptive Maintenance of Gas-Turbine Power Plant” DOI: 10.1007/978-3-030-42250-9_36.
Tanja Nemeth et al. “PriMa-X: A reference model for realizing prescriptive maintenance and assessing its maturity enhanced by machine learning” Procedia CIRP 72 (2018) 1039-1044.

This description focuses on prescriptive analytics, as well as on prescriptive maintenance, in other words on scenarios such as FUTURE-EVENT and FUTURE-ACTION. The description therefore uses terms that point to the future. For example, the computer “predicts states (or transitions)” and the computer “anticipates behavior”.

However, to obtain results regarding FUTURE-EVENT or FUTURE-ACTION, the computer may occasionally process data from the past. In other words, the computer may perform descriptive and diagnostics analytics as a basis for predictive analytics.

From a high-level perspective, it is convenient to also look at FIG. 7: Computer 200 executes a computer-implemented method (reference 403 in FIG. 7) for differentiating parameters of a particular industrial machine 101, with identifying a parameter that will become a critical parameter CP in the future.

At the present time-as illustrated by user-interface 290-computer 200 identifies the parameter that is the CP (or that becomes the CP) to operator 190. The computer could identify further critical parameters, but for simplicity, the description uses singular (“the critical parameter CP”). When the parameter is shown by interface 290, it does not have to be the CP yet.

As already explained, the CP is the parameter that will show a deviation that is critical. As explained above, there are two cascading conditions (DEV, and CRITICAL, cf. FIG. 1).

It therefore appears suitable to remove the deviation (cf. go along arrow 12 in FIG. 1). The operator may simply re-adjust the parameter or let the electronics of machine controller 105 (cf. FIG. 2) do this. After modification, the parameter would be in state CORR again. As explained above, such an easy approach applies to actuator parameters only.

This differentiation has a practical application for the performance of computer 200. In both FUTURE scenarios (to anticipate an unwanted event, or to suggest an action), there is “time pressure” for the computer to provide a result (i.e., identify the CP, to propose an action for a parameter modification or the like), before an event occurs (cf. arrows 11a and 31 in FIG. 1) and/or before the action can be taken.

Optionally, the computer therefore limits its calculation (or data processing to be more general) to parameters that are actuator parameters. Actions are expected to be promising (higher likelihood of success) for such actuator parameters. (This does not exclude the possibility that the computer processes non-actuator parameters as well).

Industrial machine 101 and computer 200 substantially operate at the same time (at least for the present and future scenarios). In other words, the operation time of machine 101 may substantially correspond to the runtime of computer 200 so that the critical parameter CP becomes visible early enough for operator 190 to apply measures in due time (before an unwanted event).

### Reference Machine

FIG. 2 illustrates the machines 101/102 in performing different roles:
Industrial machine 101 is the machine for that a particular parameter has to be identified to become a critical parameter CP (in the future), for that an action can be applied, and the like.
Industrial machine 102 (reference machine, reference role) has provided (or continues to provide) reference data that is relevant for the operation of machine 101. Providing references is a condition to predict states CORR, DEV and to predict state transitions to DEV and to CORR.

Having a reference can also be advantageous to detect DEV_CRITICAL (or to differentiate NON_CRITICAL and CRITICAL in general.) A reference could lead to a machine failure in the past. This is convenient but not required, and there are situations for that machine failure (in the past) may not be available, at least not for particular parameters.

In the vehicle example, the failure that the load falls off may simply not yet available. The vehicle may have been introduced just recently so that failure data is not available (at least for such type of failures). The computer may nevertheless detect the parameter “vibration” as a parameter that can turn into the CP, based on predictions into the future.

### Computer

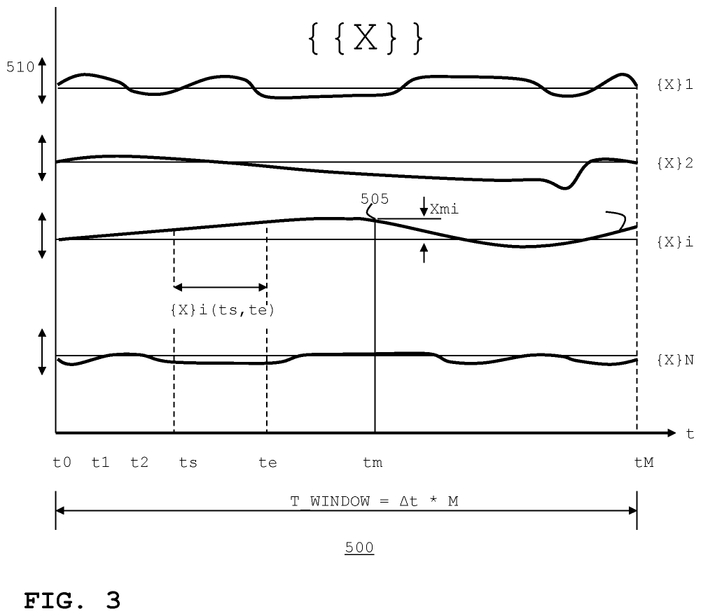

Simplified, computer 200 processes data that represent the parameters (at least some of them). Conveniently, the data are available as a multi-variate time-series {{X}} (reference 500 in the time-diagrams of FIG. 3). The skilled person obtains such data, for example, by communicatively coupling machine 101 and computer 200, so that the description does not go into such details.

Computer 200 predicts if (and when) a particular parameter becomes a critical parameter CP, the computer can identify an action that would prevent the parameter from becoming critical.

### Origin of Data in View of Time

As used herein, it is convenient to differentiate multi-variate time-series {{X}} according to the time when the time-series becomes available (for the computer) and for the time the time-series are relevant (for being processed). The description uses the term “timing aspect” and the acronyms
{{X}}_rf (reference),
{{X}}_op (operational),
{{X}}_ft (future),
{{X}}_ft_CP (future with critical parameter), and
{{X}}_ft_action (future with action).

### Reference Time-Series

Reference time-series {{X}}_rf stands for a multi-variate time-series with reference data. As in FIG. 2, {{X}}_rf is obtainable from machine 102, and reference data can have different purposes:
Reference data may provide data that represents the operation of machine 101 in normal operation mode, so that this reference data can be used to determine that a parameter is (or will be) in the state DEV. In other words, reference data may be data that represents an ideal operation of the machine.
Reference data can comprise annotations by a human expert, such as to identify situation (including states DEV_CRITICAL, DEV_NON_CRITICAL).
Reference data may provide replacement segments (in time-series to be processed), used in optional steps of the method.

The skilled person can obtain reference data, such as {{X}}_rf in a variety of implementations. Machine 102 can be regarded as a physical machine, or as an equivalent that is implemented otherwise, such as by computers (e.g., by computer 200, or by a different computer).

In a 1st implementation scenario, machines 101 and 102 are physically the same machine that act in the different roles at different times. The machine (acting as 102) has provided {{X}}_rf as historical data. Usually there would be a collection of such data.

In a 2nd implementation scenario, machines 101 and 102 are physically separate machines, that belong to a fleet of similar machines.

In a 3rd implementation scenario, machine 102 is a machine that is virtualized by a computer. The skilled person is familiar with the concept of having a digital twin (machine 101 the original, machine 102 the twin). The digital twin would provide {{X}}_rf.

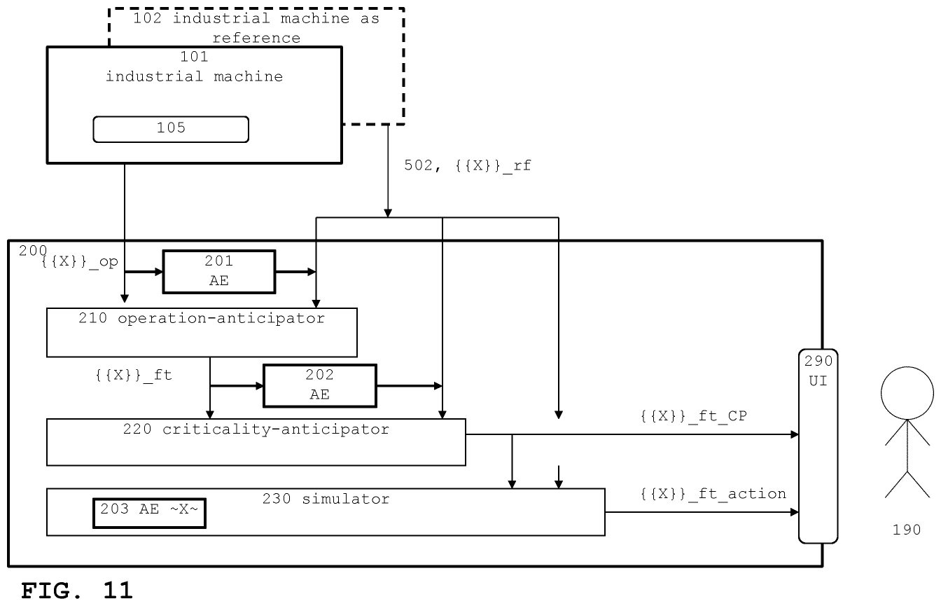

In a 4th implementation scenario, computer 200 uses auto-encoder module, details are explained in connection with FIG. 11.

In a 5th implementation scenario, computer 200 implements predefined rules. For example, the computer can detect that a single-variate time-series starts deviating (i.e., has a deviating segment) when a variate value (such as a temperature) exceeds a pre-defined threshold, and the computer can identify the end of deviating if the variate value goes below the threshold. The skilled person can apply the such and other rules otherwise (e.g., different thresholds to reflect hysteresis).

While reference time-series {{X}}_rf can have annotations that—for example—the machine has failed in the past due to some parameter values, but it such annotated reference data may not be available. In the vehicle example, reference data may point to off-standard vibration but not to vehicle failure.

### Operational Time-Series

Operational time-series {{X}}_op stands for multi-variate time-series with data that represents the operation of machine 101 during a particular operation time-interval (from t_start to t_current) that is ongoing at present. Time-point t_start should be selected such that numerical values in {{X}}_op would still influence the operation of the machine.

{{X}}_op would be obtained as measurement data from sensors, by collecting meta-data (from shop-floor applications, etc.) and the like. As mentioned, {{X}}_rf can have annotations, but for {{X}}_op there is usually no time for an expert to annotate them. With the progress of time (for example, new T_WINDOW) {{X}}_op can turn into {{X}}_rf.

### Future Time-Series

Future time-series {{X}}_ft stands for multi-variate time-series with data that represents the future operation of machine 101 (from t_predict to t_end, during T_ft). {{X}}_ft can't come from machine 101/102, but comes from computer 200 (from operation-anticipator 210).

Future time-series {{X}}_ft_CP stands for multi-variate time-series with data that represents the future operation of machine 101, but with the additional identification of the CP. This time-series is applicable from t_predict to t_end, but it becomes available at t_result. t_result follows t_predict with a delay cause by executing the method. Describing CP as part of a multi-variate time-series is convenient, because that notation can identify the time-point from that a parameter deviation becomes critical (to occur within interval T_event, cf. arrows 11a and 31 in FIG. 1). In the vehicle example, parameter “vibration” (i.e., {X}3) will be the CP.

{{X}}_ft_CP can comprise further information such as the duration during that the parameter is expected to stay critical (cf. T_event in FIG. 7 for the occurrence, but some predictions may even estimate the duration of DEV_CRITICAL).

Action time-series {{X}}_ft_action stands for a multi-variate time-series with an indication of a possible action that mitigates the effect of the (future) critical parameter deviation or that prevents critical deviations from occurring. Actions have already been discussed with FIG. 1 for differences in states and transitions, in view of (non) actuator parameters etc. The indication can take such differences into account.

In many use-cases, the action comprises the modification of a parameter (the CP if actuator parameter, other parameter to modify if CP is a non-actuator parameter). In other words, the parameter—if modified—is no longer critical (cf. arrows 12, 32 in FIG. 1). Again, the time-series notation is convenient because the action identification can be advised for a particular time-point (t_action). In view of the above-introduced human health metaphor, such an action corresponds to a pro-active activity.

As it will be explained below in connection with simulation, {{X}}_ft_action may be available in different variants. Different variants may identify different actions, and a simulator may select an appropriate action to take (from multiple action candidates)

### Modules in the Computer

FIG. 2 just mentions computer modules 210/220/230 that participate in performing a computer-implemented method.
Operation-anticipator 210 receives {{X}}_op and provides {{X}}_ft).
Criticality-anticipator 220 obtains {{X}}_ft and {{X}}_rf and provides {{X}}_ft_CP). This module performs criticality detection for the future.
Simulator 230 is an optional module that obtains {{X}}_ft_CP, and provides {{X}}_ft_action). Optionally, simulator 230 can receive {{X}}_rf as well.

User-interface 290 is a module to present {{X}}_ft_CP (or simply present CP) and/or {{X}}_ft_action to operator 190. In embodiments, module 290 can be associated by controller 105 so that actions can become control signals to the operation of machine 100.

The receiving/obtaining and providing activities of modules 210 and 220 are applicable to the so-called run-time of these modules, in steps 413 and 423, respectively, of the computer-implemented method (cf. FIG. 7). Details for simulator 230 are explained with FIG. 8.

As used herein, the term “receiving” has the connotation that data goes into the computer, and “obtaining” has the connotation that the computer generates the data by processing. For example, criticality-anticipator 220 obtains {{X}}_ft from operation-anticipator 210.

Although the notation with multi-variate time-series {{X}} suggests to process many single-variate time-series {X}i, computer 200 does not have to process all data that is available from machine 101/102. The skilled person can filter out some data.

### Module Implementations

Each of the modules can be implemented by a variety of approaches. In principle, the approaches are independent from each other. The description will shortly introduce some approaches but will give more details for some of them below.

Operation-anticipator 210 can be implemented by a variety of approaches.
Operation-anticipator 210 can be implemented by a simulator (however not simulator 230). Such simulators can be available in machine controllers, such as in controller 105 (FIG. 2).
Operation-anticipator 210 can be implemented by a machine learning (ML) tool, that has been trained in advance, for example, by processing by reference time-series {X}_rf. For training, {{X}}_rf can be obtained from multiple {{X}}_op taken from past operations, in other words training can be based on processing historical data. A prominent example for ML tools is a neural network. Operation-anticipator 210 can use a so-called auto-encoder, with details to be explained below.
Operation-anticipator 210 can also be implemented by a computer function that applies mathematical relations and thereby processes data by formulas, look-up tables or the like. For example, an industrial machine can have a water boiler as a component. Future temperature values can be calculated based on a current value {temperature}_op and on the power of the heater element. Or, a look-up table cites historic observations that remain applicable.

Operation-anticipator 210 can be implemented by combinations of these implementations, the skilled person can apply other techniques as well

Criticality-anticipator 220 can be implemented by a variety of approaches, and the two logical steps to detect criticality have already been mentioned.

To detect a state DEV, criticality-anticipator 220 can be implemented to perform, for example, the following:
Criticality-anticipator 220 can identify deviating segments in time-series, by comparing {{X}}_ft to {X}_rf, cf. FIG. 4.
Criticality-anticipator 220 can compare data that was obtained by pre-processing. For example, {X}i may comprise images (or sound sequences), and {X}i_ft and {{X}_rf can be image classifications to be compared. (An example should be the mentioned “bumpy floor”).

Criticality-anticipator 220 can replace deviating segments (in the time-series) with (corresponding) segments from the reference time-series. Such a replacement (details below) can approximate a real time-series to its references. Simplified, the difference between unmodified time-series (such as the original _op) and the modified time-series (i.e., with replacements) can be an indicator to criticality.

FIG. 2 shows simulator 230 by a single box, but in implementations this can be a module that calls the function of operation-anticipator 210 or of criticality-anticipator 220.

For example, and with details to be explained below, simulator 230 can obtain the information that one or more parameters would go to DEV in {{X}}_ft (e.g., a parameter value passes a threshold value). Simulator 230 would also obtain the information that one of the DEV parameters would go to DEV_CRITICAL in {{X}}_ft_CP. Simulator 230 could then replace the deviations (replacing, for example, by reference data, in implementations only some deviating segments) and can let operation-anticipator 210 and criticality-anticipator 220 provide {{X}}_ft_CP and {{X}}_ft_CP again. Simulator 230 could repeat the replacements for different variations. Some of the variations would result in parameter turning to the state CORR (or to DEV_NON_CRITICAL). Replacing the deviations by reference data is equivalent to modifying a parameter. After the multiple simulations, the simulator can output the action recommendation.

In the example with the vehicle, simulator 230 would obtain {{X}}_ft_CP indicating that {X}3 would change to DEV and the information that DEV in {X}3 would even be DEV_CRITICAL. Variates {X}1 and {X}2 are in DEV (because the reference has other values). The variation leads to a scenario that {{X}}_ft avoids the DEV_CRITICAL state for {X}3.

A simulation model can be local because if can relate to a part of the machine only. Such a simulation model can support the identification of the origin of the event (so that needs to be adapted to avoid the event).

FIG. 3 illustrates multi-variate time-series 500 that represent pluralities of parameters. Each variate represents a single parameter. {{X}} stands for a multi-variate time-series, with i=1 to N variates {X}i representing N parameters. Index i is the variate index (cf. FIG. 1), and N is the variate number. {{X}} comprises a plurality of single-variate time-series: {X}1, {X}2, . . . , {X}i, . . . , {X}N.

The variates {X}i are given in single-variate time-series. In alternative notation, the single-variate time-series can be given as a sequence of samples {X1 . . . XM}i.

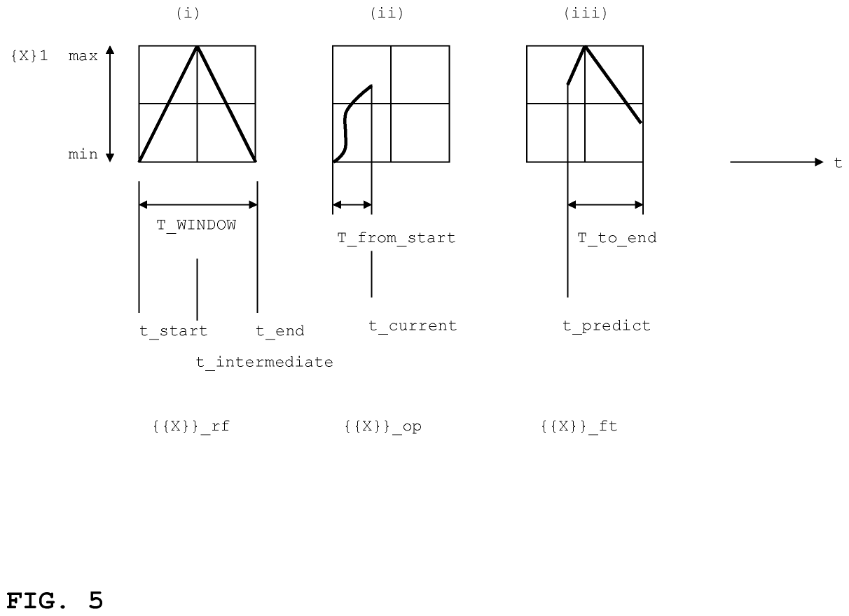

M is the number of samples in an observation interval T_WINDOW (i.e., the temporal length of the time-series), and individual samples are identified by index m. The interval has a duration of T_WINDOW=Δt*M. Δt stands for the sampling interval. T_WINDOW will again be shown in the example of FIG. 5.

As used herein, Δt is the same for all i. This is convenient for illustration, but not required in reality. Different single-variate time-series can use different sampling intervals. For example, a temperature would be measured every minute, Δt=60 seconds, but a current would be measured every second, Δt=1 second.

The notation Xmi stands for the numerical value of parameter sample 505 at time-point tm in variate {X}i. For example, Xmi could be temperature value 30 °C. As the semantics do not matter, it is possible to normalize the values. For example, for a temperature range from −30 °C to 70 °C (from “0” to “1”), the 30 °C could be processed as “0.5”. The figure illustrates variate ranges by arrows 510 (i.e., y-axes for each variate). The skilled person can apply pre-processing to filter out variate values that are not feasible. For example, a defective sensor may occasionally output a value for 1.000 °C so that such excess values can be neglected.

Time-points tm are given for the end of each sampling interval Δt. This is just a convenient convention, in other words, tm identifies the sampling interval that ends at tm.

As used herein, a time-series represents the observation interval completely, from t1 to tM. Divisions in time are called “segments”. By way of example, FIG. 3 illustrates segment {X}i (ts, te), comprising the values from Xsi to Xei. Indices “s” and “e” stand for “start” and “end” time-points for the segment. FIG. 3 shows a segment arbitrarily, a different segment with a particular meaning will be shown in FIG. 4.

As explained already, time-series represent parameters (of the industrial machine). A segment of a time-series therefore represents a parameter during a time interval, from the start to the end time-points (i.e., during a segment interval).

As the description differentiates between multi-variate and single-variate time-series by writing {{}} or {}, the description occasionally omits “multi/single-variate” or places them in parenthesis, respectively.

The description refers to time-series in that parameter samples 505 have numerical values. With or without normalization, the skilled person can code Xmi with appropriate data formats (such as real numbers in floating point numbers; integers etc.). As some the parameters would usually be represented by binary data (TRUE/FALSE, ON/OFF etc.) or even by text or strings, the skilled person can apply the method to such variates.

The skilled person can pre-process data in other formats (such as images) so that data in other formats is assigned to numerical values. An example will be illustrated at the end of the description.

FIG. 3 does not differentiate the timing aspects {{X}}_op, _rf and so on (cf. FIG. 2), but difference between them will be explained next.

FIG. 4 illustrates multi-variate time-series 500 of FIG. 3 by differentiating {{X}}_op and {{X}}_ft (collectively bold lines 501) from {{X}}_rf (dashed lines 502).

Multi-variate time-series 501 and 502 are corresponding in that reference series 502 has samples that correspond to samples in operational time-series 501:
({{X}}_op corresponds to {{X}}_rf)
({{X}}_ft corresponds to {X}_rf)

The correspondence has two aspects:
Variate correspondence means that a single-variate time-series {X}i_op has an equivalent single-variate time-series {X}i_rf, because both series refer to the same type of parameter.
Time correspondence means that for two single-variate time-series {X}i_op (or {Xi}_ft) and {X}i_rf, there are samples that are taken at the same relative time. The figure illustrates time-correspondence with vertical line 514 for {X}1.

The skilled person can identify corresponding time-series in advance, the description uses the same index i.

For simplicity it can also be assumed that the number of variates N is the same in {{X}}_op (or {{X}}_ft) and {{X}}_rf. This is convenient, but not required.

As mentioned already, reference data is usually available with tolerance bands:
{X}1_rf should have an upper and lower borders that remain constant throughout T_WINDOW. The borders have different line styles.
{X}2_rf should be similar to {X}1_rf, but with larger tolerance (here: inter-border distance)
{X}3_rf should raise during T_ WINDOW.
{X}N_rf should be constant during a relatively long time, but should fall towards the end T_WINDOW.

Tolerances should not be confused with ranges 510 (cf. FIG. 3).

Segments can be identified as well, not as arbitrarily illustrated in FIG. 3, but in relation between the single-variate time-series {X}i_op (or _ft) and {X}i_rf.

As explained above with the state-and-transition graph in FIG. 1, a parameter can change its state, states and transitions can be related to time-diagrams (as in FIG. 4) as well.

According to pre-defined rules, the computer can differentiate segments to be
deviating segments (parameter state DEV, here in the example from tDEV to tM for {X}i given as/X/i, as well as for a shorter interval for {X}N) given as /X/N, or
non-deviating segments (parameter state CORR).

As mentioned, a segment of a time-series represents a parameter during a time interval, during the segment interval. The attributes “deviating” and “non-deviating” are therefore also applicable to the parameters during the segment duration, the parameter my deviate, or the parameter may not deviate. Deviating segments therefore identify parameter deviations, quantify deviation values, or indicate variate specific errors. Deviating segments can occur during time intervals—the segment intervals—in the past, at present, or—if predicted—in the future.

For example, a first rule can define the start of deviating segment / / if the operational (or future) value Xmi_op (or Xmi_ft) starts to be different from its corresponding reference value Xmi_rf. The first rule can define the end of the deviating segment / / accordingly.

According to this first rule, time-series {X}i_op (in FIG. 4) has a deviation in segment /X/i_op because its values (Xmi) differ from the corresponding values in {X}_rf. The same principle applies to segment /X/N_op.

For this first rule, it does not matter if the reference values are higher than the operational values (as for variate i) or lower (as in variate N). A second rule could take “higher” or “lower” into account.

A third rule may be specific to time-series with binary values. For example, for a binary time-series {0, 1, 1, 1, 0), with a reference {0, 0, 0, 0, 0} there would be one deviating segment /1, 1, 1/ because the segment is not zero as in the reference.

The number of segments per time-series {X}i is limited by the number M of values within T_ WINDOW.

A fourth rule may be based on other relations. For example, if the reference time-series gives an oscillation (for example, between +1 at tm and −1 at t(m+1) and so on), and the operation (or future) time-series remains at zero (with minimal changes), there the operation (or future) time-series would quality as deviating as long as there would be no oscillation.

A fifth rule can take different reference values into account. It is convenient to take the vehicle example (cf. FIG. 6): A route taken by the vehicle corresponds (non-deviating, state CORR) a particular path class, but deviates (state DEV) from other route classes.

Likewise, deviating segments can also be determined for {{X}}_ft. The notation / / instead of {} merely indicates that the segment is a deviating segment. The computer can track the timing, for each deviating segment separately, such as by tracking start and end time-points (cf. ts, te as introduced in FIG. 3, applied to deviating segments / /).

The skilled person can select appropriate rules and can set up further rules.

### Qualifying the Segments

Having explained the basics for identifying segments (and to differentiate them into deviating and non-deviating segments), the description now discusses some more advanced observations that can be derived from segments and applied to single-variate time-series {X}i_op (or {X}i_ft likewise). The advanced observations can be related to criticality, and can be performed by the criticality detection functions (e.g., by criticality-anticipator 220).

Again, the segments are just convenient illustrations in time-diagrams to illustrate state transitions (cf. FIG. 1).

In a first category, single variate time-series can be differentiated into deviating time-series (at least one deviating segment / / required) and non-deviating time-series. FIG. illustrates {X}1 and {X}2 as non-deviating, and {X}i and {X}N as deviating.

In the same first category, there the deviating time-series could be further differentiated according to the number of deviations: multi-deviating time-series would have least two / /, and single-deviating time-series would have exactly one / /, as in {X}i and in {X}N. The number of deviations corresponds to the number of state transitions (multiple CORR to DEV transitions, or just a single transition).

In a second category, single variate time-series (with deviations) can be compared with each other by criteria such as the following:
The integral over time for the values of the (deviating) segments in difference to the values to the references can be calculated for each (deviating) time-series. Provided that two time-series use the same ranges (cf. range 510 in FIG. 3), the integrals can be compared. The two series are differentiated by their integrals.
The number of deviating segments can be used to classify time-series, simplified to differentiate frequently deviating series from occasionally deviating series. The criterium can be considered as a cross-variate criterium because multiple variates (i=1 to N) are taken into account.
The duration of the deviation can be a criteria as well. In the simplified example, {0, 1, 1, 1, 0) over the reference {0, 0, 0, 0, 0}, the deviation has a relative duration of 60 percent.

Such second category differentiation may be useful in (subsequently) determining if the deviations (DEV states, following CORR to DEV transitions) are also critical deviations (to cause abnormal operation of the machine).

### Detecting Criticality

Not every deviation (in segments or otherwise) lead to DEV_CRITICAL. In case the multiple parameters are in the states DEV, the computer can introduce a ranking. Ranking may be advantageous because it introduces robustness against the computer alerting the operator by showing potentially non-critical parameters.

By way of example, the description now explains one (optional) approach to detect criticality.

The computer (anticipator 220) can evaluate the deviating segments / / to calculate the impact of a deviation (or of the deviations).

Taking {X}i as an example, the graphical area between the dotted line and the bold line, for the time-interval from tDEV to tM (duration of the deviating segment, from the transition CORR to DEV) can quantify the deviation. The calculation is a simple integral calculation. The deviation should have the deviation value DEV(i).

Likewise, the graphical area between the dotted line and the bold lines for {X}N leads to a value DEV(N). The deviating segment is shorter.

Rules can be defined to identify criticality, the rules can be similar to the rules to identify deviations. The following is given by way of example:
A first single-variate time-series is more critical than a second single-variate time-series if the deviation value is higher (optionally, the amount of that value). For example, DEV(i)>DEV(N), so that the deviation in parameter i is critical. This is an example for criticality identification that compares deviating segments in different variates (here: i and N).
A single-variate time-series is critically deviating if the value is higher than a threshold value. This is an example for criticality identification that can stay within the variates, a comparison to other variates is not required.
A single-variate time-series can be critically in part. For example, the time-series may have a non-critical deviation and -subsequently-a critical deviation.

The deviation value DEV (i) can be considered as variate specific error. It is also possible to define an overall error ERROR, for example, as the sum for all DEV(i) from i=1 to i=N. In a modification, the overall error can be calculated as the sum for all DEV(i) squared. There are other options.

### Replacement Segments

As the computer seeks to identify an action (cf. FIG. 1), the computer (criticality-anticipator 220 in combination with simulator 230) can—for the simulation only—replace deviating segments by non-deviating segments.

This will explained for the example of FIG. 4. By dotted lines and by the notation \hat{ } \hat{ }, FIG. 4 illustrate replacement segments that correspond in time to deviating segments / /. The values of the replacement segments can correspond the reference (in the example to mid values between upper and lower tolerance values). It is also possible to calculate replacement segments by an auto-encoder. Details will be explained below.

For example, replacement segment \hat{ }X\hat{ } corresponds to deviating segment /X/i in time (the segments start and stop simultaneously), but not in the values (the deviation goes “down” but the reference goes up and the replacement takes the reference over).

For example, replacement segment \hat{ }X\hat{ }N corresponds to deviating segment /X/N, in time, but not in value.

The computer (anticipator 220) can use replacement segments \hat{ } \hat{ } to calculate the impact of a deviation.

The computer can either calculate the
the deviation values DEV(i) as explained, for the deviating segments only;
the “to-reference difference” REF_DIFFERENCE (i) (the difference between _op or _ft to _rf (to upper, or lower border, or mid-line).

For the simulation, the computer can apply variations (v1 . . . v4), for example, by selectively replacing deviating segments, or not. The computer calculates REF_DIFFERENCE (1) and REF_DIFFERENCE (2) for unchanged time-series, but for (i) and (N) the computer makes a difference.
Simulation (1) with variation v1 in that /X/i and /X/N are both replaced by \hat{ }X\hat{ }i, \hat{ }X\hat{ }N.
Simulation (2) with variation v2 in that only /X/i is replaced.
Simulation (3) with variation v3 in that only /X/N is replaced.
Simulation (4) with variation v4, no replacement.

In general, there are K variations vk (k=1 to K), the example for K=4 variation is just a simplified example.

The computer can calculate the ERROR over all variate {{X}} from i=1 to i=N, and the error will be case simulation specific. As replacement would (in theory) reduce the deviation values (in the simulation), one of simulations (2) or (3) would point to the variate that has the highest impact. (Simulations (1) and (4) may be ignored).

Other options are also applicable.

### Actions Revisited

Simplified, the most critical deviations may lead to the highest ranked action. This will be explained by way of example. In view of the above-introduced (non) actuator topic, it is noted that highest impact by simulation may not (yet) lead to the action.

### Simplified Example for Time-Series

FIG. 5 illustrates a single-variate time-series for parameter X_1 in diagrams (i), (ii) and (iii).
Diagram (i) illustrates the time-series for a complete window time-interval T_WINDOW between time-points t_start and t_end.
Diagram (ii) illustrates the time-series for a partial time-interval from the start time-point t_start to an observation time-point t_current applicable to a current operation of the industrial machine.
Diagram (iii) illustrates the time-series from a prediction time-point t_predict to the time-point t_end applicable for a future operation of the industrial machine.

In a simplified example, single-variate time-series {X}1 of the diagrams should belong to the multi-variate time-series {{X}} introduced with FIG. 3. Taking over the value-to-time notation, {X}1 is illustrated with its numerical values vertically and with the time progressing horizontally.

The T_WINDOW interval is conveniently differentiated into a first sub-interval from start time-point t_start to a time-point t_intermediate, and into a second sub-interface that follows until t_end. Both sub-intervals can have substantially equal duration, so that t_intermediate occurs approximately at T_WINDOW/2 after t_start.

As in diagram (i) of the figure, during the T_WINDOW interval, a numerical value of {X}1 should raise from a minimal value (“min”) to a maximal value (“max”) during the first sub-interval and should fall again to the minimal value during the second sub-interval. As the graph is given by straight lines, it can be assumed that the increase (or decrease) rate can be substantially constant. This is just a convenient simplification.

It can be further assumed that such an increase/decrease behavior can be derived from reference data, such as from {{X}}_rf (i.e. from multiple past occurrences of {X}1_rf, to be more specific). In other words, a training ML tool could establish {X}1_rf, there is no need for further explanation herein.

As in diagram (ii), the numerical value of {X}1 should be a measured value, cf. FIG. 2, belonging to {{X}}_op. It should raise from the minimal value (min) at t_start at least until t_current (that would be the last time-point for that operation values are available). Time-point t_current corresponds to the current time. The line does not look that straight as in diagram (i), merely to symbolize that {X}1_op would be a measured value.

As observations can't be made for the future, {{X}}_op is not available for any time in the future. However, operation-anticipator 210 (cf. FIG. 2) anticipate what happens next.

As in diagram (iii) of the figure, the numerical value of {X}1 should continue to raise (until t_intermediate) and should fall afterwards, as explained for diagram (i). The numerical value therefore belongs to {{X}}_ft (“future”).

In principle it is possible to discuss substantially all variates in {{X}}, also in the differentiation into reference (_rf), operational (_op) and future (_ft).

Detecting a deviation in {X}1 (and eventually identifying its criticality) is possible for this single variate example, but the following example with the vehicle looks at further parameters.

### Time-Series Example

FIG. 6 illustrates multi-variate time-series {{X}} with individual single-variate time-series {X}1, {X}2 and X{3} in a slightly different view, not against the process of time (as in FIG. 4) but in view of variate dependencies.

As illustrated at the top of the figure, values for {X}1 correspond to the ordinate axis (between “min” and “max”), values for {X}2 correspond to the abscissa axis (again between “min” and “max”), and values for {X}3 are represented by line thickness. In the example, the values for {X}3 are binary values, with thin and bold lines.

### Vehicle Example

It does not matter, which physical parameters the single-variate time-series {X}1, {X}2 and {X}3 actually represent. Computer 200 would be agnostic to the physical parameters, at least for a major part of the calculations. In an example, it is convenient to imagine industrial machine 101/102 as a vehicle that moves inside factory 800. Such an in-factory vehicle could move more or less autonomously. The vehicle could be battery powered. The vehicle may carry (intermediate) products and deviations in product delivery may impact the factory differently.

While the vehicle battery may be replaced or re-charged easily (if needed) and the arrival delay would be negligible, the destruction of the load would be very difficult to deal with. (In view of the above-mentioned ranking, load destruction would be a top ranked deviation.) The overall complexity does matter here. As a side note, the factory itself can be seen as an industrial system with the vehicle as just one of its component. The vehicle can also be considered as an example for a machine that organizes maintenance with only minimal interactions from human operators.

For that example, the figure also show factory 800 in view from above. In a usual process step (or rather transport step), the vehicle should move within factory 800 from first corner 801 (at min/min position) to second corner 802 (at max/max position), and it should return to first corner 801. It could deliver an intermediate product across the factory, for example from corner 801 to corner 802. In other words, the vehicle would return from corner 802 without load.

{X}1 and {X}2 would represent two coordinates of the vehicle position. The transport step would have an average duration of T_WINDOW. Not all transports would require the same time.

In that scenario, {X}1 in combination with X{2} would represent path 805 of the vehicle. {X}1 would be approximately change over time as illustrated in FIG. 4, not necessarily at constant speed, but the position {X}1 would change from “min” to “max” and again to “min”. The same applies to {X}2.

Path 805 can go through particular areas within factory 800, such as areas 811 and 812. The figure symbolizes areas 811 and 812 by rectangles with round corners, but the shape of the areas does not matter. The computer can detect the vehicle to be in areas 811 and 812 based on the (X1, X2) coordinates, at any time within {X}_op.

For convenience of illustration, {X}3 could be assigned to a meaning as well, for example to mechanical vibration of the vehicle. To stay with binary values, there should be vibration in the magnitudes “weak” and “heavy”, again a binary distinction to keep the example as simple as possible. Of course, the skilled person can identify threshold values or the like, and even the difference between both binaries could be established by machine learning. It should be noted that the computer treats the values as numerical values, and that “weak” or “heavy” or other semantics are used here for convenience of explanation only.

Reference data {{X}}_rf should be as in FIG. 4 for {X}1 and {X2} (i.e., increase and decrease) and should also be available for {X}3_rf. By way of example, {X}3 should be “heavy” for (X1, X2) coordinates that within area 812. This applies to {{X}}_rf as well as to {{X}}_op.

It is also possible to combine {X}1 and {X}2 and the classify reference paths. For example, there is
a “wall path” class for the vehicle moving near the walls as in case (A),
a “diagonal path” class for the vehicle moving the shortest way, as in in case (B), or
a “wall-diagonal path” class as in (C).

The class names in quotation marks “ ” are given here arbitrarily, the computer does not have to use them.

It can be assumed that {{X}}_rf is a collection of historical data that—in the vehicle example—document past movements, perhaps in a 50/40/10 per cent distribution for cases (A), (B) and (C).

FIG. 5 further illustrates a further modality difference: Operation values {{X}}_op are given by white circles, and future values {{X}}_ft are given by black circles. The figure is again simplified in showing approximately 10 values per trip. A more realistic in-factory vehicle would require a couple of minutes and data sampling intervals AT every second are suitable. Therefore, a single transport step (i.e., a round trip) would provide a couple of 100 values.

Prediction accuracy may simply deteriorate with increasing temporal distance. The black circles at the end of the paths may be larger than the black circles for earlier time-points.

### Operation Anticipation

Operation-anticipator 210 processes {X}_op and would therefor anticipate values for each single-variate time-series {X}1, {X2} (for example, parameter “position” with two coordinates) and {X3} (for example, parameter “vibration”). The last white circles (a) in (A), (b) in (B) and (c) in (C) symbolize the position (X1, X2) at time-point t_current. (Reference time-series {X}_rf has its share as well, for example, if operation-anticipator 210 would be implemented as a machine-learning tool trained with historical reference data).

For example, based on the first position coordinates (X1, X2) it receives, operation-anticipator 210 can anticipate if the vehicle takes a “wall path” as in (A) or takes a “diagonal path” as in (B).

Operation-anticipator 210 also anticipates values for {X}3, depending on the paths. For example, if the vehicle moves through area 811 (at t_current), it will experience some “heavy” vibration in area 812.

Diagram (A) shows position (a) at t_current in area 811 by a white circle, and shows black circles in area 811 (over a thin line, “weak vibration”) and in area 812 (bold line, heavy vibration). For diagrams (B) and (C), operation-anticipator 210 anticipates movement along the diagonal path, but the vibrations would be anticipated to be “weak”.

In other words, operation-anticipator 210 has anticipated or predicted—at least partially-the remaining path. The figure shows black circles for anticipated positions. It may not yet differentiate the return paths from corner 802 in (B) and (C), but it anticipates {X}3 at least together with the anticipated positions.

### Deviation

It should be assumed that vibration cannot be avoided. For {X}3_ft corresponding to area 812, criticality-anticipator 220 would identify the vibration values as deviating segments (cf. the two black circles, on the bold line). In other words, criticality-anticipator 220 would predict a transition in {X}3 from CORR to DEV, for a time-point in the future (cf. T_event in FIG. 7). (In other words, “weak” corresponds to CORR, and “heavy” corresponds to DEV).

### Detection of Criticality

It can also be assumed that—at a relatively early time-point t_predict cf. FIG. 7) criticality-anticipator 220 also anticipates the new state to be DEV_CRITICAL (not only DEV but DEV_CRITICAL). (There might be some other parameters, or observations from the past, such as DEV_CRITICAL because of the further parameter that the vehicle carries a load (from corner 801 to corner 802). In other words, an event (cf. bold arrow 11a) would occur during T_event and the event would change the state of X3.

It is possible that criticality-anticipator 220 outputs {{X}}_ft_CP (to operator 190, via user interface 290) with the identification that CP=X3 (“vibration”) with the estimated time-interval T_event. For example, the computer can output the identified future event together with a warning (to operator 190). (In the example, {{X}}_ft_CP could also be accompanied by the indication of the vehicle location).

### Simulation

Outputting the warning may not be sufficient. In a factory, the operators may be occupied with other task so that the vehicles come second in their attention.

Simulator can perform the simulation (herein the two variations to go along the wall or to diagonally), with the position (X1, X2) as the parameter to be varied (actuator parameter). The ERROR would be calculated and one simulation would show that “vibration” could be minimized.

Of course, the computer operates agnostic to the semantics, and would potentially calculate DEV(1) and DEV(2) as potentially contributing to errors, but going different paths does not contribute to the overall performance of the vehicle.

FIG. 7 illustrates a time-diagram for steps that are performed by computer 200 performing computer-implemented method 403.

Method 403 comprises
operation-anticipator 210 to anticipate the operation of machine 101, with providing {X}_ft, in step 413, and
criticality-anticipator 220 to anticipate an event in that a parameter shows a deviation that becomes critical (DEV_CRITICAL, critical transition, by arrows 11a or 31 in FIG. 1), in step 423.

The illustration in FIG. 7 as well as the description are simplified by assuming that the critical transition will occur. However, criticality-anticipator 220 may also perform step 423 with the result that a critical transition will not occur.

FIG. 7 further illustrates that operation-anticipator 210 and criticality-anticipator 220 can be implemented by machine-learning tools, wherein steps 412 and 422 stand for training steps, for the modules, respectively. Training can be considered as training method 402. It is however noted that training is only applicable for such an implementation, wherein other implementations have been introduced already (cf. FIG. 2). For training, reference time-series {{X}} serve as historical data.

To place the step execution into the context of data availability, FIG. 7 illustrates the availability of multi-variate time-series {{X}} in {{X}}_rf, {{X}}_op, {{X}}_ft and {{X}}_ft_CP. The progress of time is illustrated by a time axis from left to right, but the axis is not scaled.

The steps are symbolized by boxes, with the left sides of the boxes projected to the earliest time-point to start performing a step, and with the right side of the boxes projected to earliest time-point when results from step performance can be used (for subsequent activities).

The availability of {{X}} is symbolized by horizonal lines that are drawn in parallel to the time axis. The horizontal lines can be dashed to indicates that time-series are available, but not necessarily used by modules 210/220.

Vertical lines (with arrows) go (usually from the horizonal lines) to boxes indicate that time-series {{X}} in a particular modality is supplied (at least partially) to module 210/220.

### Time-Points and Time-Intervals

The description now (re)introduces time-points and time-intervals, in chronological order.

Time-point t_collect symbolizes that collecting {{X}}_rf started in the past. Knowing the exact time-point t_collect is not required. Collecting could have started years ago.

Time-point t_train_1 symbolizes that training steps 412 and 422 start. Step 412 stands for a process to train operation-anticipator 210, and step 422 stands for a process to train criticality-anticipator 220, if implemented by machine-learning tools. Training usually becomes possible when suitable time-series {{X}}_rf are available. This is also illustrated by vertical arrows 1 and 2 from {{X}}_rf to the left sides of boxes 412, 422, respectively.

Time-point t_train_2 symbolizes that training has been performed such that operator-anticipator 210 is able anticipate the operation of machine 101 (cf. FIG. 2), and criticality-anticipator 220 is able to identify states DEV_CRITICAL.

In the figure, training of both modules 210/220 is illustrated to start and stop simultaneously at t_train_1, and t_train_2, respectively. This is a mere simplification of the figure, but not required in reality. Training can continue for new {{X}}_rf that becomes available.

From time-point t_train_2, operation-anticipator 210 and criticality-anticipator 220 are ready to be used, but supplying data by these modules is not yet required.

Time-point t_start symbolizes that industrial machine 101 starts a new operation cycle so that {{X}}_op becomes gradually becomes available from t_start (cf. the example for the vehicle leaving corner 801, in FIG. 6).

Time-point t_current indicates the time for that {X}_op is available with the most up-to-date data. T_op is the operation time-interval that is ongoing at present (i.e., from t_start to t_present). From time-point t_current, operation-anticipator 210 starts performing step 413 (“anticipating”) that comprises receiving {{X}}_op. The vertical arrow 3 symbolizes that operation-anticipator 210 processes {{X}}_op (as far as available, from t_start to t_current). In the example, the vehicle would be at positions at the last white circles (a), (b) or (c), cf. FIG. 6.

The operation of the machine is ongoing after t_current, and the time it takes operation-anticipator 210 to perform step 413 is relatively short (in comparison to T_op, the figure is not scaled).

Time-point t_predict indicates the earliest time-point by that operation-anticipator 210 provides {{X}}_ft as the result (cf. the right side of the box). The figure is again simplified here, because performing step 413 can continue. With the process of time, more and more data in {{X}}_op become available so that {{X}}_ft should become more accurate. In the illustration of FIG. 5, the black circles would become smaller.

The time-interval from t_current to t_predict can be regarded as the run-time of operation-anticipator 210. In an ideal situation, {{X}}_op would continue to be available also at t_predict so that operation-anticipator 210 can repeat the step. As a consequence and in view of FIG. 6, the black circles would become smaller.

Vertical arrow 4 symbolizes the data hand-over of {{X}}_ft to criticality-anticipator 220.

Time-point t_predict therefore indicates the earliest time-point by that criticality-anticipator 220 can start performing step 423. As illustrates by vertical arrows 5 and 6, criticality-anticipator 220 does not have to rely on {{X}}_ft but optionally can processes {{X}}_rf and {{X}}_op.

At time-point t_result, criticality-anticipator 220 has identified a critical state DEV_CRITICAL to occur in the future, for at least one parameter (i.e., the future is after t_result).

The figure illustrates the result by a further horizonal line for {{X}}_ft_CP, that is simplified-the multi-variate time-series for the future {{X}}_ft with computer-generated annotations. For example, the annotations could indicate the particular single-variate time-series {X}i in that the deviation is expected to occur, the start and end time-points of the variation, a numerical estimation, or the like, here symbolized by “CP” critical parameter.

The vertical arrow 7 just illustrates that {{X}}_ft_CP comes from criticality-anticipator 220 performing step 423.

The time-interval from t_predict to t_result can be regarded as the run-time of criticality-anticipator 220. (As criticality-anticipator 220 processes {{X}}_ft but not {{X}}_op, the amount of data to be processed is relatively small compared to the amount of data that is available for processing.) Due to that relatively short run-time, t_result would be before a deviation will occur.

Time-interval T_event indicates a time-interval for that criticality-anticipator 220 anticipates the transition to DEV_CRITICAL, i.e., the event to be avoided. T_event is given as an interval.

Time-point t_end indicates the latest time-point for that operation-anticipator 210 can predict {{X}}_ft. In other words, there is a prediction time-interval (T_ft) from t_future to t_end. The figure illustrates this time-point to symbolized that anticipation is limited in time.

To summarize this overview, at time-point t_result, computer 200 informs operator 190 that during T_event (in the future, relative to t_result) a particular event (i.e., a parameter is turning critical) is to be expected. Operator 190 may then take an appropriate action, usually with the goal to avoid this event.

The description will explain how computer 200 can assist operator 190 to find an appropriate measure (or “action”). The description will refer to FIG. 8, but a short look at the vehicle example should be helpful.

### Timing Aspects in View of the Vehicle Example

Computer 200 (with operation-anticipator 210 and criticality-anticipator 220) does not have to process semantics. It is however convenient for illustration to shortly look at FIGS. 6-7 again.

From time-point t_trained, operation-anticipator 210 will be able to predict the vehicle path, and will also able to predict some heavy vibrations in area 812. Assuming that at t_current the vehicle has approached the “wall” path, operation-anticipator 210 will provide {X}3_ft in that heavy vibrations are anticipated (cf. the black dots over the bold line in FIG. 6, case (A). If at t_current, the vehicle enters the diagonal path, {X}3_ft would show “weak” vibrations (black circles over a thin line, FIG. 6, case (B)).

As the heavy vibration is not necessarily recognized as a critical event (an event that transits to DEV_CRITICAL, cf. the bold arrows in FIG. 1), the deviation identifier may not have identified such a variance in vibration as a deviation. It may have recognized other deviations.

Assuming that the predicted path (via area 812), criticality-anticipator 220 (optionally receiving {{X}}_rf) can identify {X}3 as deviating during T_event (i.e., when the vehicle will go through area 812).

### Simulation

FIG. 8 illustrates a continuation of the time-diagram for further step 433 that is performed by simulator 230, together with further data availability graphs.

FIG. 8 repeats steps 413 and 423 and introduces step 433 as a simulating step (by simulator 230).

As already explained, operation-anticipator 210 performs step 413 (at least initially) from t_current to t_predict; and criticality-anticipator 220 performs step 423 (at least initially) from t_predict to t_result.

From time-point t_result, {{X}}_ft_CP is available, (horizontal line) and simulator 230 can start to simulate (step 433), simulator 230 identifies an action, and a time-point for taking this action (t_action). Time-point t_action would be before T_event. (The computer is under “time-pressure” again.

Simulator 230 performs simulation in step 433 by the following sub-steps:
(1) modifying critical parameters (or modifying other parameters) to a set of variations,
(2) for each variation, by predicting the machine operation for modified parameters (implemented for example by calling operation-anticipator 210 to update {{X}}_ft),
(3) by evaluating {{X}}_ft to determine if the variations still lead to a parameter becoming DEV_CRITICAL or not,
(4) by selecting the variation with the lowest impact (i.e., least significant) on the operation (e.g., that avoids the event (during T_event), or that shifts the occurrence of the event to the more distant future (in the drawings to the right)—the impact can be selected according to pre-defined rules, or by pre-trained modules—and
(5) optionally, by outputting the selection as recommended action (or by outputting the identification of the parameter that was replaced for deviating segments / / to \hat{ } \hat{ }so that operator 190, cf. FIG. 2, understands what should be done as action).

The description has introduced simulator 230 above as an optional module (cf. FIG. 2) and continues with explaining details. In other words, outputting the selection (optionally in the context of {{X}}_ft_CP) allows operator 190 to modify parameters (provided that the parameters can be modified, “actuators”). In view of the CP, the selection may correspond to the CP but does not have to.

The sub-steps are investigated with more detail:
(1) Simulator 230 does not modify parameters in reality; it modifies the data that represents parameters. Simulator 230 does not—for example—change a temperature or lets the machine vibrate less. It merely changes data. Modifying a single parameter to have at least two different values leads to a set of two variations, but more realistically are modifications to multiple parameters (among them the parameter that was predicted to becomes critical (to DEV_CRITICAL). The description will explain examples for a vehicle with modified parameters such as vibration, path etc. and for a bearing with four parameter in 12 variations.
(2) Simulator 230 calls operation-anticipator 210, and it is noted that for the variations, operation-anticipator 210 provides the “would-be” operation. As the parameters are not changed in reality (i.e., not at machine 101, but only in simulation), “would-be” operation are not necessarily the “to-be”operations.
(3) In a couple of paragraphs below, the description refers to the vehicle example: a particular variation (the selection of a particular path) would avoid the parameter “vibration” from turning critical. The description here gives the negative example, because operator 190 is interested to avoid parameters to become critical (cf. the action in FIG. 1, such as action 611a.)
(4) and (5) The selection of the variation with the lowest (or in other words “least impact”) does not force operator 190 to apply the variation. Outputting the selection is to be understood as a recommendation. Although given in singular terms, the selection could comprise multiple variations, so that the operator makes the final selection.

### Vehicle Example

As mentioned, industrial machines can be very complex, and having approximately N=3 variates is merely a simplification for explanation.

Computer 200 can use simulator 230 to simulate alternatives. In the example, X3 “vibration” can't be modified, but the parameter pair (X1, X2) stands for the position of the vehicle being modifiable parameters. (In other notation, the parameter pair are actuator parameters.)

Simulator identifies two paths together with a re-anticipation of X3:
the “wall path”, with X3 expected to become critical (CP=X3)
the “diagonal path” with X3 expected to stay CORR

Simulator 230 will then output the “diagonal path” as a suggested action (to be performed as t_action). In other words, the position can be modified by simply not allowing the vehicle to enter area 812 and by letting the vehicle take the alternative path. FIG. 6 shows this alternative path in (D).

It is noted that simulator 230 provided the alternatives, by varying actuator parameters (the vehicle has actuators to changes its path), but not by varying non-actuator parameters (vibration can't be avoided, hence X3 can't be simulated to become “weak”)

Consequently, operator 190 could interact with the vehicle (not for all cases, but only if it approaches area 812) to let it take an alternative path, as illustrated in case (D). Initially, operation-anticipator 210 may have provided {{X}}_ft already, and due to the path change, {{X}}_ft would become obsolete, but operation-anticipator 210 can calculate {{X}}_ft again, for the alternative path.

More in detail, simulator 230 lets modules 210 and 220 repeat some calculations. Simulator 230 modifies the (simulated, not real) positions (X1, X2) for a first variation with the remaining path that has been predicted in {{X}}_ft, that is position (a1) in case (A), black circle. Likewise, simulator 230 modifies (X1, X2) for positions that vehicle can also reach (shortly).

Simulator 230 calls for an updated prediction, the first variation would indicate X3 to be “heavy” (because the vehicle would be predicted to be in area 812) and the second variation would lead to X3 being “weak” (outside area 812).

Simulator 230 would re-evaluate (by calling criticality-anticipator 220) both variations, but there would be no deviation for the second variation (X3 would remain “weak”). There would be an impact indeed (the vehicle would take an alternative path), but that impact is acceptable (the impact being, for example, just as a negligible delay in the arrival of the vehicle back at corner 801).

Simulator 230 would select the second variation because X3 would be expected to be “weak”.

Simulator 230 would output the selection as recommended action, for example with a modified position instruction. FIG. 6 illustrates this for case (D), the vehicle avoids area 812.

### Root Cause

Industrial machines provide a great variety of data, and that can be used here. To stay with the vehicle example: it can be considered as a machine as well, and the description explains further aspects by referring to this example. Position X1, X2 and vibration X3 are parameters, but the presence (or absence) of load at the vehicle would be a further vehicle parameter X4.

It can be assumed that further data regarding the factory is available, such as a collection of images per position, as X5 (potentially not for each and every position, but in sufficient quantities to have images along the paths (also for predicted paths). The images do not have to be available as time-series, but as the vehicle moves along the path, a collection of images can be considered as a de-facto time-series.

The images can be classified (image processing is state of the art), and classifiers (that are the result of classifying) can be used as input data (for anticipator 210, for detector 220, for simulator 230). The images should be classified because they show the floor in two classes. For example, individual images are classified into “bumpy floor” or “smooth floor”. The bumpy floor would be the (root) cause of vibration.

The computer can eventually relate the floor to the vibration so that the (actuator-like) action would be to: take the alternative path (as in FIG. 6(D)) unless the floor is repaired.

### Example for a Bearing

It does not matter if the action (cf. the output of simulator 230) relates to the operation of the machine (take a particular path that avoids a particular area), or relates to a special mode (in that operation may be stopped, such as during maintenance in many situations). The description continues by discussing an action (to avoid abnormal operation) by referring to the example of a bearing.

FIG. 9 illustrates a symbolic illustration of a bearing (two concentric circles for the inner and outer rings), with parameters of the data types “temperature”, “number of rotations”, “torque”, “pressure” (of oil), and “oil-type”. The figure also symbolizes the temperature going up so that the bearing will fail. Such a typical time-series can be considered as {temperature}_rf, for “failure”. Failure can be associated with a drop in rotation (e.g., to 600 rpm) of a rotor that is supported by the bearing. In view of the above introduced deviations: the sudden temperature rise can be regarded as a transition from CORR to DEV_CRITICAL (cf. FIG. 1).

Adding or changing oil is a well-established approach to avoid or to delay failure (cf. action 611 in FIG. 1). But again, the computer does not necessarily implement a rule that considers the oil type, the example is however convenient for explanation.

FIG. 10 refers to the bearing of FIG. 9 and illustrates simulation of the temperature parameter {temperature} for variations v1 . . . v12 in four actuator parameters (“load”, “oil_type”, pressure” and “torque”). Simulator 230 (in cooperation with operation-anticipator 210) would simulate with three different ranges #1, #2 and #3 per input parameter, thus resulting in 4×3=12 temperature values changing over a time-interval (such as during T_WINDOW or during a shorter interval). In the example, there are K=12 variations, and K=12 simulations. For simplicity, FIG. 10 illustrates four temperature-over-time diagrams only (instead of 12 diagrams for K=12 simulations).

In other words, time-series would be available from {temperature}|#1 #1 #1 #1_ft (variation v1, with “load”, “oil_type”, pressure” and “torque” all having value #1, dashed line) to {temperature}|#3 #3 #3 #3_ft (variation v2, with values #3, dashed line as well).

The values # are specific to the parameters. For example, for the parameter “load”, the values could be #1=“not loaded”, #2=“50% loaded” and #3=“full load”. There could be three different oil types, type #1, type #2 and type #3. The acronym _ft points to the future. Simulation data does not have to be equivalent to operation data _op.

One of the time-series corresponds to the failure scenario of FIG. 9, and the computer can recognize a particular temperature pattern as corresponding to the failure reference. Other time-series would show a scenario to use a different oil type (as action).

In terms of the states and transitions in FIG. 1, {temperature}|#1 #1 #1 #1_ft corresponds to {temperature}_rf (of FIG. 9).

### Selected Parameter Value

In performing method step 433 (simulation), simulator 230 can select the parameter variation with the least impact on the operation of the particular industrial machine (101). There could be more than one variation. In the example, the variations with oil type #2 has the least impact. FIG. 10 illustrates variation v2=#1, #2, #1 by way of example. (#, #2, #would be more general: The oil type matters, the other parameters not). Since operator 190 (cf. FIG. 2) can understand from the temperature curve (no substantial heating) that a selection with oil type #2 is potentially beneficial, the curve is also given as “{temperature}_ft_action”, this notation is a particular example for {{X}}_ft_action (cf. FIG. 2).

In other words, the action to run the bearing with oil of type #2 can be regarded as action 611 (cf. FIG. 1) because the action would keep the temperature as CORR.

### Causal Relation

As already mentioned above with FIG. 1, parameters depend on each other in their effect.

While FIG. 1 differentiates actions 611, 612 etc. according to transitions (to prevent or to support transitions), the computer does not have to consider the causal relations in all its exactness.

Simulations allow to compare parameter changes in view of their effects (to the operation of machine in general, and/or to state changes for parameters in particular). For the vehicle example, simulator 230 may modify a further (actuator) parameter, such as vehicle speed {X}7, and going at low speed may reduce the vibrations as well (actions 611, 612 in FIG. 1). The computer may not take the semantics into account, so there would be just a further parameter {X}7 to change (action 612 in FIG. 1). The computer could then rank the different actuator parameters.

The computer could also rank different actions (being equivalent to rank parameters). Actions with higher rank have to preference to be performed, over actions with lower rank.

The above introduced differences between actions (cf. FIG. 1) can be considered in the ranking. Action 632 (that remove criticality) may have a higher rank than action 611 (that keeps CORR).

The actions “reducing the speed” and “going an alternative path” both reduce the likelihood to encounter vibration (and the risk that the load falls off the vehicle), but the actions may have different efficiency. The computer may give “going the alternative path” a higher rank (also because the delay impact would be negligible for that action, the vehicle would substantially arrive in time). Both actions could be considered actions 611 or 612 in FIG. 1.

In the example for the bearing, changing the oil type (e.g., to #3) may have a higher rank than, for example, changing the oil pressure.

### Discussion Regarding Super-Vision

The approach has presented a solution for prescriptive maintenance, but a history about past actions (such as maintenance) does not have to be available. Such an approach would be an unsupervised approach.

In the vehicle example, processing reference data {{X}}_rf allows to predict X3 to become DEV (even DEV_CRITICAL) in the future, but there is not history regarding the action available. There is no historical data available for the vehicle taking an alternative path (cf. FIG. 6(d).

In the simulation, the “best” actuator parameters are parameter for that the simulation resulted different criticality in the sharpest contrast: the simulated “wall-path” leads to (simulated) “heavy” vibrations, and the simulated “diagonal path” leads to (simulated) “weak” vibration. The simulation may have resulted in other parameters, such as in different transport durations (i.e., T_WINDOW as a parameters expected to different for the paths). However, the different was highest for the vibrations (from “heavy” to “weak”) and not for the duration (perhaps a minute earlier arrival time). This difference in parameter evaluation does not have to be communicated to the computer by supervision, the computer selects the parameter with the sharpest contrast automatically, there is no need for supervision.

Likewise, historical data (part of {{X}}_rf) comprises data regarding maintenance (e.g., to re-charge the vehicle battery) and regarding failures (e.g., battery failure, that lead to re-charge). But historical data does not have to comprise data regarding all types of failure. The loaded vehicle may not have fallen down (in the past), but a potentially dangerous situation could have been prevented (by the vehicle going the alternative path).

Avoiding supervision (by human experts) is not possible in all situations, but the computer-implemented method as explained can be used to identify actions for factories that are operated more and more autonomously.

### Timing

As explained, computer 200 (by simulator 230) proposes actions, and there should be no substantial delay. The time-intervals (t_current to t_predict, operation-anticipator; t_predict to t_result, criticality-anticipator) need to be short enough to let the computer deliver a result before an event can occur ({{X}}_ft_OP) and before an action can be taken ({{X}}_ft_OP_action). The operation of the computer modules can be speed up by simplifying:
The identification of DEV states allows to ignore parameters that do not deviate, hence criticality-anticipator 220 does not have check CORR parameters.
Actions can be identified for actuator parameters only. Such an approach reduces the number of candidates for that actions are identified. The approach can include to limit the variations to actuator parameters. In other words, an actuator that would be unable to be changed in reality would remain “without action” during simulation. For example, the parameter “vibration” with its two values “heavy” and “weak” results from varying other parameters (such as position, path etc.) and varying the vibration to a particular value would not correspond to reality and can be avoided.

### Auto-Encoder

Deep auto-encoders can be employed to identify features that can be used to train architectures that are explained in papers, such as by: Karl-Philipp Kortmann, Moritz Fehsenfeld, Mark Wielitzka, “Autoencoder-based Representation Learning from Heterogeneous Multivariate Time Series Data of Mechatronic Systems”, arXiv: 2104.02784.

Auto-encoders are explained in scientific papers, such as in “Cyriana M.A. Roelofs, Marc-Alexander Lutz, Stefan Faulstich, Stephan Vogt: Autoencoder-based anomaly root cause analysis for wind turbines. Energy and AI 4 (2021) 100065”.

Auto-encoders can be convolutional auto-encoders, or LSTM auto-encoders, or any other structures that can process sequential data, with an example explained in “Roy Assaf, loana Giurgiu, Jonas Pfefferle, Serge Monney, Haris Pozidis and Anika Schumann ‘An Anomaly Detection and Explainability Framework using Convolutional Autoencoders for Data Storage Systems’, Proceedings of the Twenty-Ninth International Joint Conference on Artificial Intelligence (IJCAI-2000) Demonstrations Track”.

FIG. 11 repeats the illustration of industrials machines 101 and 102 and computer 200 of FIG. 2, but adds examples for the optional use of auto-encoders 201, 202 and 203:
In the example, auto-encoder 201 receives {{X}}_op and provides {{X}}_rf (in addition or alternatively to {{X}}_rf from machine 102).
In the example, auto-encoder 202 receives {{X}}_ft and provides a reference, not as {{X}}_rf from machine 102 but rather as a reference based on prediction.
In the example, simulator 203 uses auto-encoder for various purposes, such as to identify replacement segments \hat{ }X\hat{ } (to replace deviating segments in the above-described variations, before simulation) In other words, auto-encoder 203 can also be used to calculate replacement segments \hat{ } \hat{ } (cf. the example for \hat{ }X\hat{ }1 and \hat{ }X\hat{ }N in FIG. 4).

Illustration and explanation are simplified. For example, the auto-encoder do not have to encode multi-variate time-series with all variate, but can apply auto-encoding to some variates only.

For approach that has been described, the use of an auto-encoder is convenient to established {{X}}_rf (or other data), even in situations in that historical data is sparse. Also, the use of auto-encoders may be advantageous because the efforts for human experts to annotate relevant features (in {{X}}_rf) can be reduced.

For example, a deviation as in FIG. 4, /X/i is illustrated by values that are different from values in a reference band, but potentially human experts need to define these reference bands (with upper and lower borders, etc.)

In a different example, the auto-encoder could differentiate the future path of the vehicle, to go along the walls, or along the diagonal. In that sense, operation data {{X}}_op (for the position, the white circles in 6) act as the code that let the computer (here: operation-anticipator 210) derive the future path.

### Multi-Modality and Variate Pre-Processing

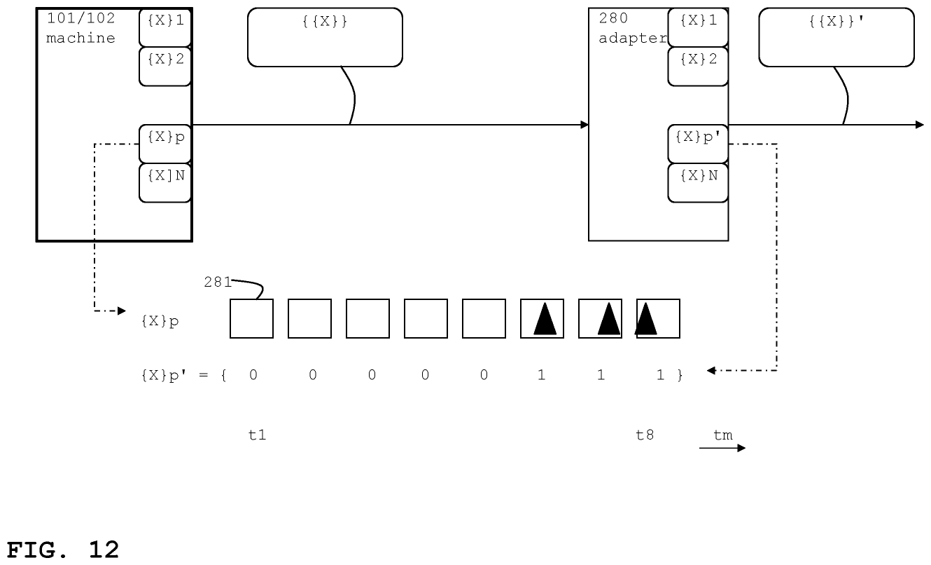

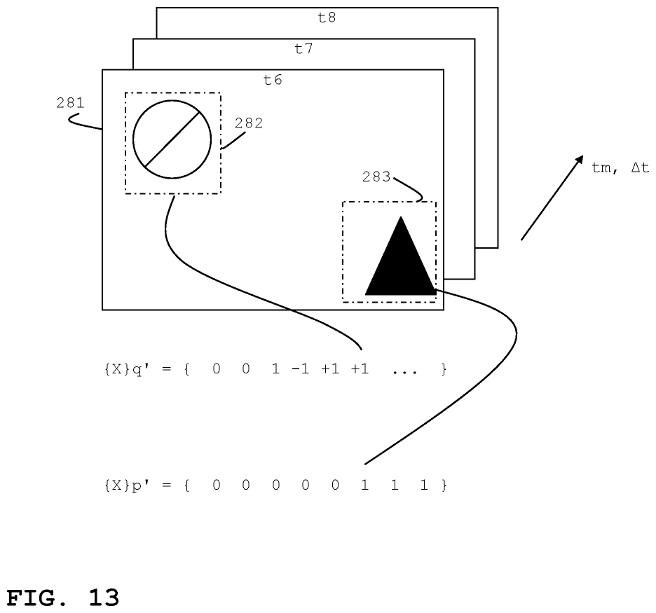

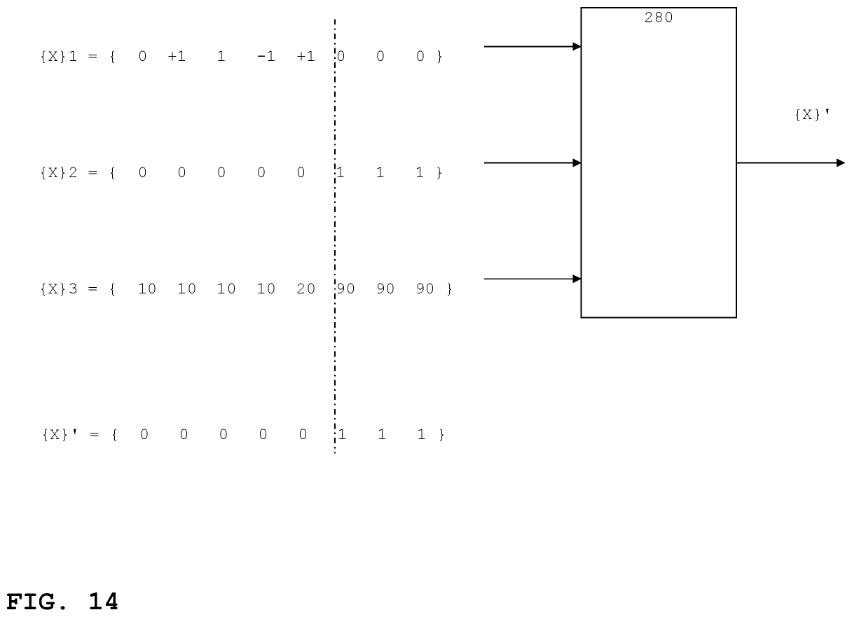

FIGS. 12-14 illustrate variate pre-processing. More in detail, FIG. 12 shows adapter 280 with image data to be adapted, FIG. 13 shows image data being adapted, and FIG. 14 shows data aggregation by adapter 280.

Adapter 280 can be implemented as part of the module that performs the anticipating step (cf. step 413). By way of example, FIG. 12 illustrates adapter 280 for pre-processing data from industrial machine 101 (or from machine 102). Adapter 280 receives (one or more) multi-variate measurement time-series from industrial machine 101 or from reference machine 102. The figure is simplified by letting all N variates go through the adapter, but in implementations, not all variates need to be adapted.

As noted above, the notation Xmi stands for the numerical value of parameter sample 505 at time-point tm in variate {X}i, cf. FIGS. 3-4 illustrate parameter samples as scalars. The skilled person can receive (or obtain) the samples by well-known approaches, such as by collecting measurement data, by collecting meta-data (from shop-floor applications, etc.)

However, data capturing is not limited to scalars. It is possible to apply data pre-processing that adapts the data modality, for example, from image data to scalar data, from sound data to scalar data, from vector data to scalar data, etc.

In other words, adapter 280 can optionally implement a modality adaptation of data that is originally available as non-scalar data. By way of example, this adaptation is shown for variate {X}p.

Data for variate {X}p could be a collection of digital images 281 (i.e., matrices with pixels that indicate colors). The images could be taken by a camera or by a scanner.

Images 281 can be available as a sequence of images (e.g., for images every Δt, in the figure from t1 to t8). In view of the above vehicle example, the images could show for example the floor of the factory.

Adapter 280 can process the images and can assign them scalar values here shown as time-series {X}p′. The dash ′ merely indicates that the assignment took place. The skilled person can apply image processing techniques such as classification, by a pre-trained neural network or otherwise.

For example, the images can show movable machine components (or non-movable parts such as the floor). Adapter 280 can classify the components as “bumpy” or “not bumpy” (binary classification for the floor), as moving at speed “0”, “1”, “2”, “3” etc. (for moving parts).

As the floor may be bumpy, the images can be classified accordingly. Much simplified, an image showing bumps can be coded to 1 (“bumps are present”), and an image without them could be coded to 0 (“absent”). FIG. 16 shows the bumps quite symbolically by triangles. The resulting single-variate time-series could be {X}p′ with parameters samples {0, 0, 0, 0, 0, 1, 1, 1}′, cf. 505, as “op”, and the computer would perform the method as described, with {X}p′. Assuming that the reference would be {X}p′_rf with parameter samples {1, 1, 1, 1, 0, 0, 0, 0}, a deviation could be determined as unexpected “no bumps” at the beginning and unexpected “bumps” at the end of the WINDOW.

The skilled person can adapt sampling rates if needed. For example, image data may arrive as a video stream (with 25 image frames per second), and some frames may be removed to arrive at Δt (that may be much longer than 1/25 second).

In a further scenario (not illustrated by the drawings, but easily to imagine), the non-scalar elements could be sound sequences. For example, {X}p can be a collection of audio records (or “sound records”, for example, each having a duration of Δt or less) from a microphone sensor. The person skilled in the art can apply appropriate sound processing, for example, by sampling the sound at a frequency of 20 kHz, leading to 60*20,000 audio samples per minute. For the vehicle example, it is noted that the vehicle passing a bumpy floor might make some characteristic sound.

In the context of providing time-series with Δt spacing, adapter 280 would then process these millions of samples to single scalars. For example, the scalar could indicate: pitch rising during Δt, pitch falling Δt, pitch constant during Δt, pitch rising and falling during Δt and so on. Such patterns could be assigned to integers, or the varying pitch itself can be assigned to parameter samples.

FIG. 13 shows image data being adapted as shown in FIG. 12, but with a modification. Here, adapter 280 also receives an image sequence (shown for times tm=t6, t7 and t8) but assigns scalar values in two or more (single-variate) time-series, here given as {X}p′ and {X}q′ (the dash ′ again standing for the assignments). Adapter 280 identifies areas 282, 283 within images 281, and processes the data for the areas separately. In the example, area 282 shows a machine component (circle symbol in the drawing) that rotates in direction sense “+1”, or rotates in direction sense “−1”, or does not rotate at all “0”, as illustrated for the assignments in {X}p′. Area 283 shows a “fire” (triangle symbol) corresponding to “1” or shows “no fire” at “0”. In the example, the figure shows image 281 at time t6 (rotation in “+1”, fire is present).

Processing data requires computation resources (such as CPU, memory etc.) and the overall time to identify the critical parameter (with the state transition) may be critical (cf. the real-time requirement mentioned above.) The examples of FIGS. 12-14 show that pre-processing (with assigning non-scalar data to scalar data) may save resource consumption.

It is noted that pre-processing sound samples or images by the adapters simplifies the implementation. By being specific to sound samples or images, the adaptors remove complexity from the anticipator. The anticipator had to process scalars, not sounds, not images.

FIG. 14 shows data aggregation, and the applying such aggregation may also contribute to resource saving. As explained above (FIGS. 4-5), multi-variate time-series {{X}} are sets of single-variate time-series {X}i. It is possible to identify sub-sets (of single-variate time-series) and aggregate them before the method is being executed. For executing the method, the computer can use aggregated times-series, at least partially.

The figure shows an example, in that three single-variate time-series {X}1, {X2}, {X3} belong to {{X}}. They are aggregated to single-variate time-series {X}′. {X}′ would then be part of multi-variate time-series for that the method is performed.

In the example, {X}1 and {X}2 would indicate position (of the vehicle) and {X}3 would indicate the vibration.

Just to illustrate this by an example, a motor (or vehicle) being forced to stop (or a vehicle that vibrates) makes some characteristic noise and potentially heats up. A domain expert can define an appropriate rule so that {X}′ would change (e.g., from 0 to 1, from t6).

Further, data aggregation (i.e., a complexity reduction from N to 1, N to 2, N to “small number” is explained in papers such as Zhihua Zhang, Michael I. Jordan, “Latent Variable Models for Dimensionality Reduction”, Proceedings of the Twelfth International Conference on Artificial Intelligence and Statistics, PMLR 5:655-662, 2009; and W. Wang, Y. Huang, Y. Wang and L. Wang, “Generalized Autoencoder: A Neural Network Framework for Dimensionality Reduction,” 2014 IEEE Conference on Computer Vision and Pattern Recognition Workshops, 2014, pp. 496-503.

For scenarios introduced in FIGS. 12-14, adapter 280 can be implemented by a neural network that has been trained before, potentially under supervision (by human experts). For example, adapter 280 could have been trained with annotated images showing bumps, annotated sound sequences, and so on. Adapter 280 can also be trained in an unsupervised manner in order to identify an abstract representation of the image (or sound). That ensures the maximization of the informative content of the image. A sequence of images (or sounds) can then be reduced by this process to sequences of scalars.

To identify areas within images (cf. FIG. 13), the skilled person can apply techniques from autonomous driving (e.g., the car computer differentiates traffic signs from pedestrians). Statistics may play a role in training the network, in applying rules and so on.

Similar expert involvement can be applied to the selection of the sub-set to be aggregated (cf. FIG. 14). Selecting sub-sets (of time-series) virtually divides the industrial machine into groups, and the selection can take the components (cf. 110, 120, 130) into account.

Single-variate time-series that the adapter provides (such as {X}′, {X}p′, {X}p′ in FIGS. 16-18) can optionally be related to a semantic. Such semantics are frequently called by metaphorical terms such as “health index” or “operation status”. In the example with the motor, {X}′ has been obtained by aggregation and would be rather a “motor problem index” that symbolizes a potential malfunction of one machine component (i.e., a particular motor). In that sense, {X}′ does not yet show a critical parameter, but may let the computer find the (root) cause faster (cf. the scenarios with the vehicle and the bearing). In other words, {X}′ may show CR at relatively low accuracy, but accurate enough to let the computer further investigate the machine, and not yet to investigate machine components. {X}′ allows prioritizing, thus saving computation resources.

### Generic Computer

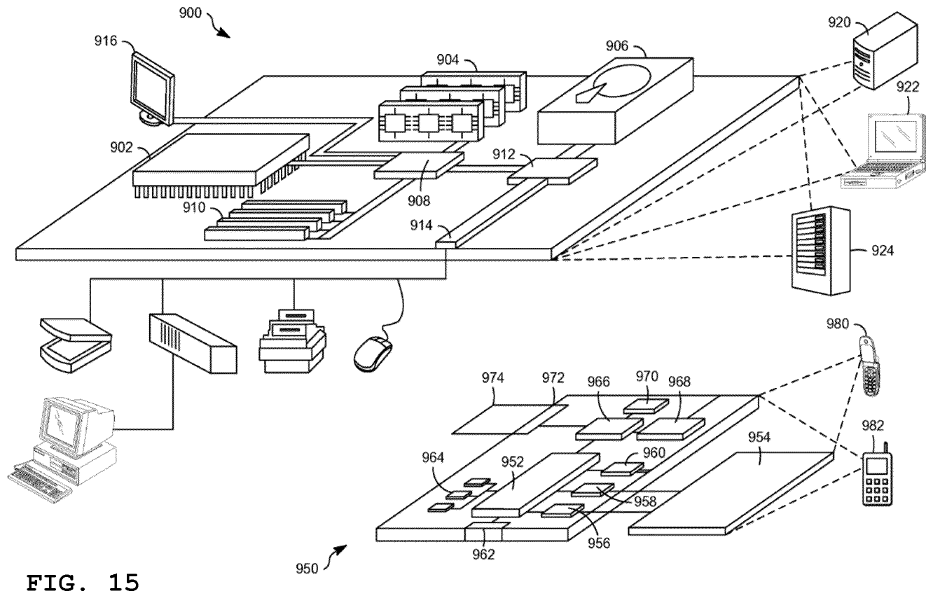

FIG. 15 illustrates an example of a generic computer device which may be used with the techniques described here. FIG. 15 is a diagram that shows an example of a generic computer device 900 and a generic mobile computer device 950, which may be used with the techniques described here. Computing device 900 is intended to represent various forms of digital computers, such as laptops, desktops, workstations, personal digital assistants, servers, blade servers, mainframes, and other appropriate computers. Generic computer device may 900 correspond to the computer system 200 of FIG. 2. Computing device 950 is intended to represent various forms of mobile devices, such as personal digital assistants, cellular telephones, smart phones, driving assistance systems or board computers of vehicles and other similar computing devices. For example, computing device 950 may be used as a frontend by a user (e.g., an operator of a blast furnace) to interact with the computing device 900. The components shown here, their connections and relationships, and their functions, are meant to be exemplary only, and are not meant to limit implementations of the disclosures described and/or claimed in this document.

Computing device 900 includes a processor 902, memory 904, a storage device 906, a high-speed interface 908 connecting to memory 904 and high-speed expansion ports 910, and a low speed interface 912 connecting to low speed bus 914 and storage device 906. Each of the components 902, 904, 906, 908, 910, and 912, are interconnected using various busses, and may be mounted on a common motherboard or in other manners as appropriate. The processor 902 can process instructions for execution within the computing device 900, including instructions stored in the memory 904 or on the storage device 906 to display graphical information for a GUI on an external input/output device, such as display 916 coupled to high speed interface 908. In other implementations, multiple processors and/or multiple buses may be used, as appropriate, along with multiple memories and types of memory. Also, multiple computing devices 900 may be connected, with each device providing portions of the necessary operations (e.g., as a server bank, a group of blade servers, or a multi-processor system).

The memory 904 stores information within the computing device 900. In one implementation, the memory 904 is a volatile memory unit or units. In another implementation, the memory 904 is a non-volatile memory unit or units. The memory 904 may also be another form of computer-readable medium, such as a magnetic or optical disk.

The storage device 906 is capable of providing mass storage for the computing device 900. In one implementation, the storage device 906 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 904, the storage device 906, or memory on processor 902.

The high speed controller 908 manages bandwidth-intensive operations for the computing device 900, while the low speed controller 912 manages lower bandwidth-intensive operations. Such allocation of functions is exemplary only. In one implementation, the high-speed controller 908 is coupled to memory 904, display 916 (e.g., through a graphics processor or accelerator), and to high-speed expansion ports 910, which may accept various expansion cards (not shown). In the implementation, low-speed controller 912 is coupled to storage device 906 and low-speed expansion port 914. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 900 may be implemented in a number of different forms, as shown in the figure. For example, it may be implemented as a standard server 920, or multiple times in a group of such servers. It may also be implemented as part of a rack server system 924. In addition, it may be implemented in a personal computer such as a laptop computer 922. Alternatively, components from computing device 900 may be combined with other components in a mobile device (not shown), such as device 950. Each of such devices may contain one or more of computing device 900, 950, and an entire system may be made up of multiple computing devices 900, 950 communicating with each other.

Computing device 950 includes a processor 952, memory 964, an input/output device such as a display 954, a communication interface 966, and a transceiver 968, among other components. The device 950 may also be provided with a storage device, such as a microdrive or other device, to provide additional storage. Each of the components 950, 952, 964, 954, 966, and 968, are interconnected using various buses, and several of the components may be mounted on a common motherboard or in other manners as appropriate.

The processor 952 can execute instructions within the computing device 950, including instructions stored in the memory 964. The processor may be implemented as a chipset of chips that include separate and multiple analog and digital processors. The processor may provide, for example, for coordination of the other components of the device 950, such as control of user interfaces, applications run by device 950, and wireless communication by device 950.

Processor 952 may communicate with a user through control interface 958 and display interface 956 coupled to a display 954. The display 954 may be, for example, a TFT LCD (Thin-Film-Transistor Liquid Crystal Display) or an OLED (Organic Light Emitting Diode) display, or other appropriate display technology. The display interface 956 may comprise appropriate circuitry for driving the display 954 to present graphical and other information to a user. The control interface 958 may receive commands from a user and convert them for submission to the processor 952. In addition, an external interface 962 may be provide in communication with processor 952, so as to enable near area communication of device 950 with other devices. External interface 962 may provide, for example, for wired communication in some implementations, or for wireless communication in other implementations, and multiple interfaces may also be used.

The memory 964 stores information within the computing device 950. The memory 964 can be implemented as one or more of a computer-readable medium or media, a volatile memory unit or units, or a non-volatile memory unit or units. Expansion memory 984 may also be provided and connected to device 950 through expansion interface 982, which may include, for example, a SIMM (Single In Line Memory Module) card interface. Such expansion memory 984 may provide extra storage space for device 950, or may also store applications or other information for device 950. Specifically, expansion memory 984 may include instructions to carry out or supplement the processes described above, and may include secure information also. Thus, for example, expansion memory 984 may act as a security module for device 950, and may be programmed with instructions that permit secure use of device 950. In addition, secure applications may be provided via the SIMM cards, along with additional information, such as placing the identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 964, expansion memory 984, or memory on processor 952 that may be received, for example, over transceiver 968 or external interface 962.

Device 950 may communicate wirelessly through communication interface 966, which may include digital signal processing circuitry where necessary. Communication interface 966 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 968. In addition, short-range communication may occur, such as using a Bluetooth, WiFi, or other such transceiver (not shown). In addition, GPS (Global Positioning System) receiver module 980 may provide additional navigation- and location-related wireless data to device 950, which may be used as appropriate by applications running on device 950.

Device 950 may also communicate audibly using audio codec 960, which may receive spoken information from a user and convert it to usable digital information. Audio codec 960 may likewise generate audible sound for a user, such as through a speaker, e.g., in a handset of device 950. Such sound may include sound from voice telephone calls, may include recorded sound (e.g., voice messages, music files, etc.) and may also include sound generated by applications operating on device 950.

The computing device 950 may be implemented in a number of different forms, as shown in the figure. For example, it may be implemented as a cellular telephone 980. It may also be implemented as part of a smart phone 982, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing device that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing device can include clients and servers. A client and server are generally remote from each other and typically interact through a communication network. The relationship of client and server arises by virtue of computer programs running on the respective computers and having a client-server relationship to each other.

A number of embodiments have been described. Nevertheless, it will be understood that various modifications may be made without departing from the spirit and scope of the disclosure.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims

1. A computer-implemented method for identifying a parameter state transition with a predicted occurrence in the future, wherein the parameter state transition is a critical transition due to a predicted increase in the likelihood that the operation mode (X_mode) of an industrial machine changes in the future, wherein the operation mode is a technical state of the machine;
wherein the computer processes multi-variate time-series ({{X}}), being pluralities of single-variate time-series ({X}i), wherein each single-variate time-series ({X}i) represents a parameter (X_i) of the industrial machine, the method includes the following steps:
anticipating the operation of the industrial machine,
by processing an operational multi-variate time-series ({{X}}_op) that represents the operation of the industrial machine during an operation time-interval (T_op) that is ongoing at present (t_current), and
by providing a future multi-variate time-series ({X}_ft) that represents the predicted operation of the industrial machine during a prediction time-interval (T_ft) that reaches into the future; and
processing the future multi-variate time-series ({X}_ft) to anticipate the parameter state transition under the and-related conditions that the computer:
(a) for parameters that are represented by single-variate time-series as part of the future multi-variate time-series ({X}_ft), determines that at least one parameter (X3) is predicted (DEV) to have a value that will be different from a reference value in at least one deviating segment (/X/i), and
(b) by quantifying the deviation (DEV(i)) in that deviating segment for the at least one parameters, and by applying pre-defined rules, determining that the likelihood for the change in the operation mode of the industrial machine is predicted to be increased.

2. The method according to claim 1, wherein the computer performs anticipating the operation of the industrial machine by an operation-anticipator module (210) that is implemented, selected from the following: by a simulator; by a machine learning tool, that has been trained in advance with operational multi-variate time-series from past operations; and by a computer function that applies mathematical relations and thereby processes data by formulas or look-up tables.

3. The method according to claim 1, wherein the computer performs anticipating the parameter state transition by a criticality-anticipator module that is adapted to identify deviating segments in the single-variate time-series, by comparing the future multi-variate time-series ({X}_ft) with a reference multi-variate time-series ({X}_rf), for each single-variate time-series separately,
so that deviating segments thereby identify parameter deviations, quantify deviation values, or indicate variate specific errors that are predicted to occur during segment intervals in the future.

4. The method according to claim 1, wherein the computer performs anticipating the parameter state transition by a criticality-anticipator module that is adapted to identify differences between numerical values that are obtained by pre-processing images or sound samples.

5. The method according to claim 1, wherein the computer performs anticipating the parameter state transition by a criticality-anticipator module that has been trained in advance to determine the likelihood increase of the change of the operation mode (X_mode) of the industrial machine, wherein the criticality-anticipator module has been trained with historical data regarding the machine mode, wherein the machine mode serves as ground truth at the output, and data relating to parameters and quantified deviations serves as input data.

6. The method according to claim 1, wherein the computer further performs a step simulating, by the following:
modifying the representation of the at least one parameter (X3) to obtain a set of parameter variations (v1 . . . v4, v1 . . . v12), wherein in the least one single-variate time-series that represents the at least one parameter (X3), the computer replaces deviating segments (/X/1, /X/N) by replacement segments (~X~1, ~X~N) obtained from a reference or generated with an auto-encoder; for each parameter variation (vk) separately, anticipating the operation of the industrial machine, and evaluating if the at least one parameter (X3) would still have the value that would differ from the reference value and would still change the likelihood of the change in the operation mode (X_mode) of the industrial machine; and
selecting the parameter variation with the least impact on the operation of the industrial machine.

7. The method according to claim 6, being also a method for identifying an action, with outputting the selected parameter variation as recommended action to an operator of the industrial machine.

8. The method according to claim 6, wherein the computer limits the data processing during simulation to parameters that are actuator parameters.

9. The method according to claim 1, wherein the parameter state transition indicates the industrial machine turning to the operation mode that is abnormal machine operation.

10. A computer program product that, when loaded into a memory of a computer system and executed by at least one processor of the computer system, causes the computer system to perform the steps of a computer-implemented method according to claim 1.

11. A computer system comprising a plurality of modules which, when executed by the computer system, perform the steps of the computer-implemented method according to claim 1.

12. Use of the computer system of claim 11 further including the step of differentiating parameters of an industrial machine to identify a subset of parameters that are critical parameters that cause abnormal operation of the industrial machine.
